(19) United States
(12) Patent Application Publication
(10) Pub. No.: US 2016/0192338 A1
(43) Pub. Date: Jun. 30, 2016

(54) RADIO BASE STATION, USER TERMINAL AND REFERENCE SIGNAL TRANSMISSION METHOD

(71) Applicant: NTT DOCOMO, INC., Tokyo (JP)

(72) Inventors: Anass Benjebbour, Tokyo (JP); Yoshihisa Kishiyama, Tokyo (JP)

(73) Assignee: NTT DOCOMO, INC., Tokyo (JP)

(21) Appl. No.: 14/392,165

(22) PCT Filed: Mar. 10, 2014
(86) PCT No.: PCT/JP2014/056193

§ 371 Date: Dec. 23, 2015

(30) Foreign Application Priority Data
Jun. 28, 2013 (JP) 2013-135706

(51) Int. Cl. H04W 72/04; H04B 7/06; H04L 27/26

(52) U.S. Cl. CPC H04W 72/044; H04L 27/2613; H04B 7/0617

(57) ABSTRACT

The present invention is designed to improve the received quality of reference signals in user terminals, in small cells that are placed to overlap a macro cell. The reference signal transmission method according to the present invention is a reference signal transmission method in a radio base station that forms a small cell, which is placed to overlap a macro cell, and that has a plurality of antenna ports, and includes the steps of generating a plurality of reference signals that vary per antenna port, and in a reference signal transmission period in which beamforming is not executed, transmitting the plurality of reference signals in a transmission bandwidth that is narrower than in a second transmission period in which beamforming is executed, the reference signals of each antenna port are spread in at least one of the time direction and the frequency direction and transmitted.

### TECHNICAL FIELD

The present invention relates to a radio base station, a user terminal and a reference signal transmission method in a next-generation mobile communication system in which a macro cell and a small cell are placed to overlap each other.

### BACKGROUND ART

In LTE (Long Term Evolution) and successor systems of LTE (referred to as, for example, “LTE-advanced,” “FRA (Future Radio Access),” “4G,” etc.), a radio communication system (referred to as, for example, a “HetNet” (Heterogeneous Network)) to place small cells (including pico cells, femto cells and so on) having a relatively small coverage of a radius of approximately several meters to several tens of meters, to overlap a macro cell having a relatively large coverage of a radius of approximately several hundred meters to several kilometers, is under study (for example, non-patent literature 1).

For this radio communication system, a scenario to use the same frequency band in both the macro cell and the small cells (also referred to as, for example, “co-channel”) and a scenario to use different frequency bands between the macro cell and the small cells (also referred to as, for example, “separate frequencies”) are under study. To be more specific, the latter scenario is under study to use a relatively low frequency band (for example, 2 GHz) (hereinafter referred to as the “low frequency band”) in the macro cell, and use a relatively high frequency band (for example, 3.5 GHz or 10 GHz) (hereinafter referred to as the “high frequency band”) in the small cells.

### CITATION LIST

### Non-Patent Literature

Non-Patent Literature 1: 3GPP TR 36.814 “E-UTRA Further Advancements for E-UTRA Physical Layer Aspects”

### SUMMARY OF INVENTION

### Technical Problem

In the radio communication system in which the macro cell uses the low frequency band and the small cells use the high frequency band, from the perspective of increase in capacity, offload and so on, it is preferable that user terminals communicate in the small cells where the high frequency band of the greater capacity is used.

Meanwhile, since the path loss of the high frequency band is significant compared to the path loss of the low frequency band, the high frequency band has difficulty securing a wide coverage. Consequently, when the high frequency band is used in the small cells, there is a problem that user terminals have difficulty receiving reference signals from the small cells in sufficient received quality.

The present invention has been made in view of the above, and it is therefore an object of the present invention to provide a radio base station, a user terminal and a reference signal transmission method, whereby small cells that are placed to overlap a macro cell can improve the received quality of reference signals in user terminals.

### Solution to Problem

The radio base station of the present invention is a radio base station that forms a small cell, which is arranged to overlap a macro cell, and that has a plurality of antenna ports, and this radio base station has a generating section that generates a plurality of reference signals that vary per antenna port, and a transmission section that, in a first signal transmission period in which beamforming is not executed, transmits the plurality of reference signals in a transmission bandwidth that is narrower than in a second transmission period in which beamforming is executed, and the transmission section spreads and transmits the reference signals of each antenna port in at least one of a time direction and a frequency direction.

### Advantageous Effects of Invention

According to the present invention, small cells that are placed to overlap a macro cell can improve the received quality of reference signals in user terminals.

### BRIEF DESCRIPTION OF DRAWINGS

FIG. 1 is a conceptual diagram of a HetNet;

FIG. 2 is a diagram to explain examples of carriers used in a macro cell and small cells;

FIG. 3 is a diagram to explain massive MIMO;

FIG. 4 provides diagrams to explain the (one-dimensional) relationship between frequency and the number of antenna elements;

FIG. 5 is a diagram to explain the (two-dimensional) relationship between frequency and the number of antenna elements;

FIG. 6 is a diagram to explain small cell coverages;

FIG. 7 is a diagram to explain reference signal transmission periods;

FIG. 8 is a conceptual diagram of a reference signal transmission method according to example 1.1 of the present invention;

FIG. 9 is a diagram to explain a reference signal transmission method according to example 1.1 of the present invention;

FIG. 10 is a diagram to explain an example of spreading of reference signals according to example 1.1 of the present invention;

FIG. 11 is a conceptual diagram of a reference signal transmission method according to example 1.2 of the present invention;

FIG. 12 a diagram to explain a reference signal transmission method according to example 1.2 of the present invention;

FIG. 13 is a conceptual diagram a reference signal transmission method according to example 2.1 of the present invention;

FIG. 14 is a diagram to explain a reference signal transmission method according to example 2.1 of the present invention;

FIG. 15 is a conceptual diagram of a reference signal transmission method according to example 2.2 of the present invention;

FIG. 16 is a diagram to explain a reference signal transmission method according to example 2.2 of the present invention;

FIG. 17 is a diagram to explain a reference signal transmission method according to example 3.1 of the present invention;

FIG. 18 is a diagram to explain a reference signal transmission method according to example 3.2 of the present invention;

FIG. 19 is a diagram to explain a reference signal transmission method according to example 4.1 of the present invention;

FIG. 20 is a diagram to explain a reference signal transmission method according to example 4.2 of the present invention;

FIG. 21 is a schematic diagram to show an example of a radio communication system according to the present embodiment;

FIG. 22 is a diagram to explain an overall structure of a radio base station according to the present embodiment;

FIG. 23 is a diagram to explain an overall structure of a user terminal according to the present embodiment;

FIG. 24 is a diagram to explain a functional structure of a small base station according to the present embodiment; and

FIG. 25 is a diagram to explain a functional structure of a user terminal according to the present embodiment.

### DESCRIPTION OF EMBODIMENTS

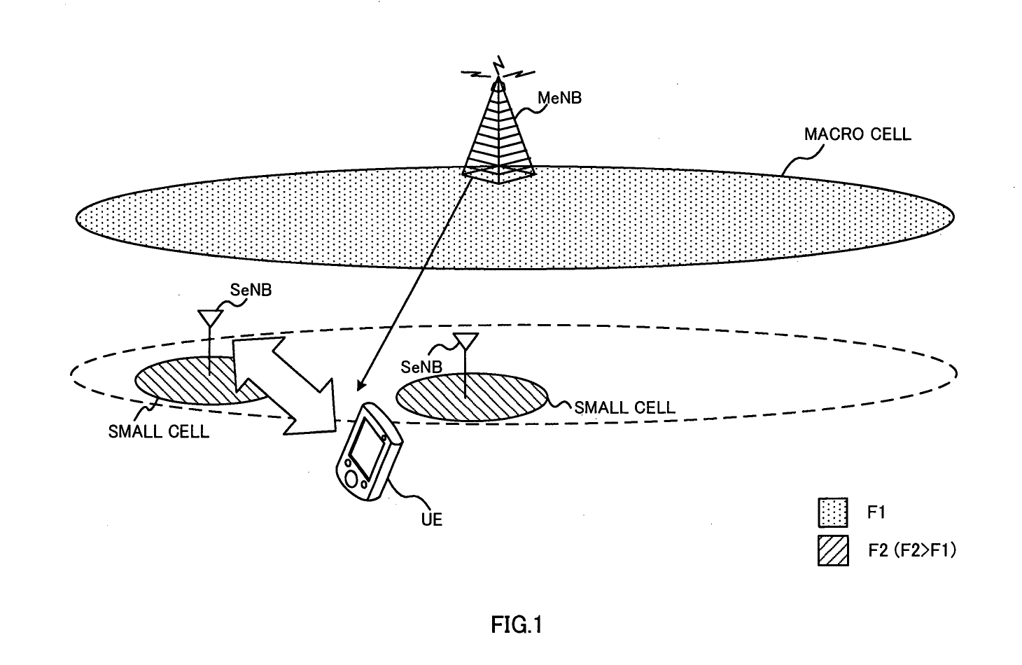

FIG. 1 is a conceptual diagram of a HetNet. As shown in FIG. 1, a HetNet refers to a radio communication system in which small cells are arranged to overlap a macro cell geographically. A HetNet includes a radio base station (hereinafter referred to as the “macro base station”) (MeNB: Macro eNodeB) that forms a macro cell, radio base stations (hereinafter referred to as the “small base stations”) (SeNB: Small eNodeB) that each form a small cell, and a user terminal (UE: User Equipment) that communicates with the macro base station and at least one of the small base stations.

In the HetNet shown in FIG. 1, a study is in progress to use a carrier F1 of a relatively low frequency band (hereinafter referred to as the “low frequency band”) in the macro cell, and use a carrier F2 of a relatively high frequency band (hereinafter referred to as the “high frequency band”) in the small cells. In this case, a study is also in progress to secure coverage and carry out mobility support in the macro cell that uses the carrier F1 of the low frequency band, and increase capacity and carry out offloading in the small cells that use the carrier F2 of the high frequency band (also referred to as “macro-assisted,” “C/U-plane split,” etc.).

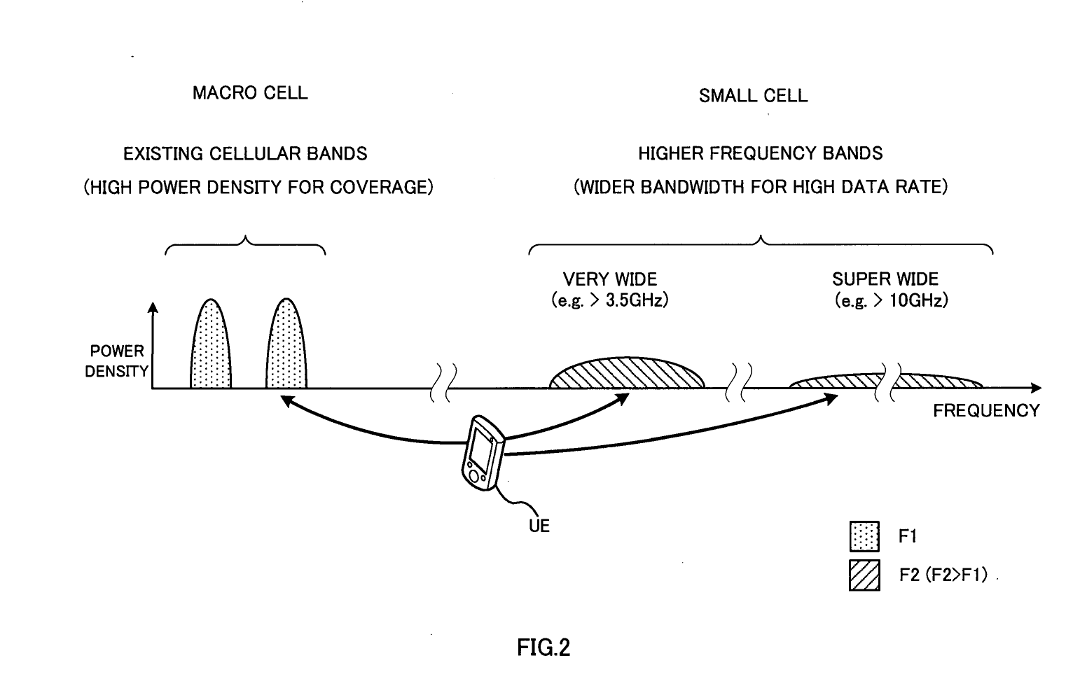

FIG. 2 is a diagram to show examples of the carriers F1 and F2. As shown in FIG. 2, it is possible to use, for the carrier F1 of the low frequency band, a carrier of an existing frequency band (existing cellular band) such as, for example, 800 Hz and 2 GHz. On the other hand, for the carrier F2 of the high frequency band, it is possible to use a carrier of a higher frequency band than the existing frequency band, such as, for example, 3.5 GHz and 10 GHz.

As shown in FIG. 2, the transmit power density of the carrier F1 is higher than the transmit power density of the carrier F2, so that the macro cell has a greater coverage than the small cells. Meanwhile, the transmission bandwidth of the carrier F2 (bandwidth) can be secured wider than the transmission bandwidth of the carrier F1, so that the small cells achieve higher transmission speeds (capacity) than the macro cell.

Now, path loss increases in proportion to frequency f. To be more specific, path loss is roughly represented by 20*log 10(f). Consequently, in the small cells where the carrier F2 of the high frequency band is used, a study is in progress to compensate for path loss by applying beamforming by means of massive MIMO (also referred to as “three-dimensional (3D)/massive MIMO”) and so on.

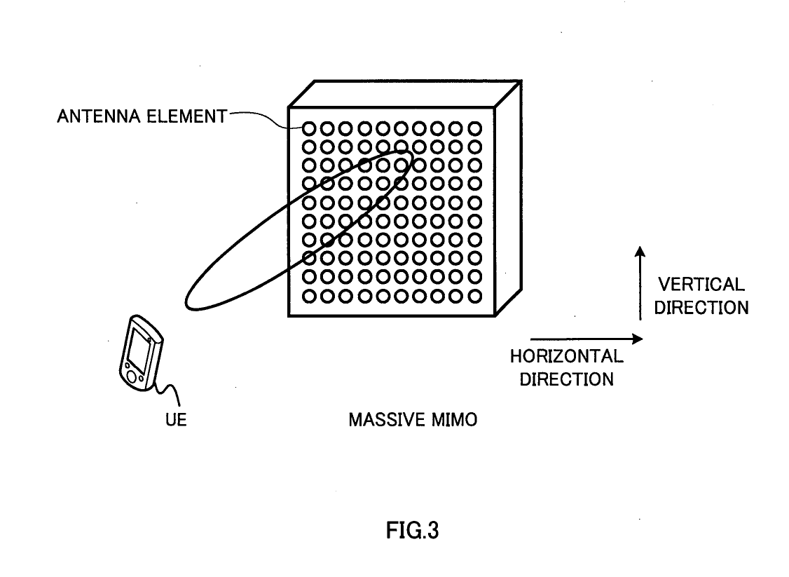

FIG. 3 is a diagram to explain massive MIMO. When massive MIMO is used, a plurality of antenna elements are arranged on a two-dimensional plane. For example, as shown in FIG. 3, a plurality of antenna elements may be arranged evenly between the horizontal direction and the vertical direction on a two-dimensional plane. In this case, in theory, the number of antenna elements that can be arranged on the two-dimensional plane increases in proportion to the square of frequency f. Note that, although not illustrated, a plurality of antenna elements may be arranged three-dimensionally as well.

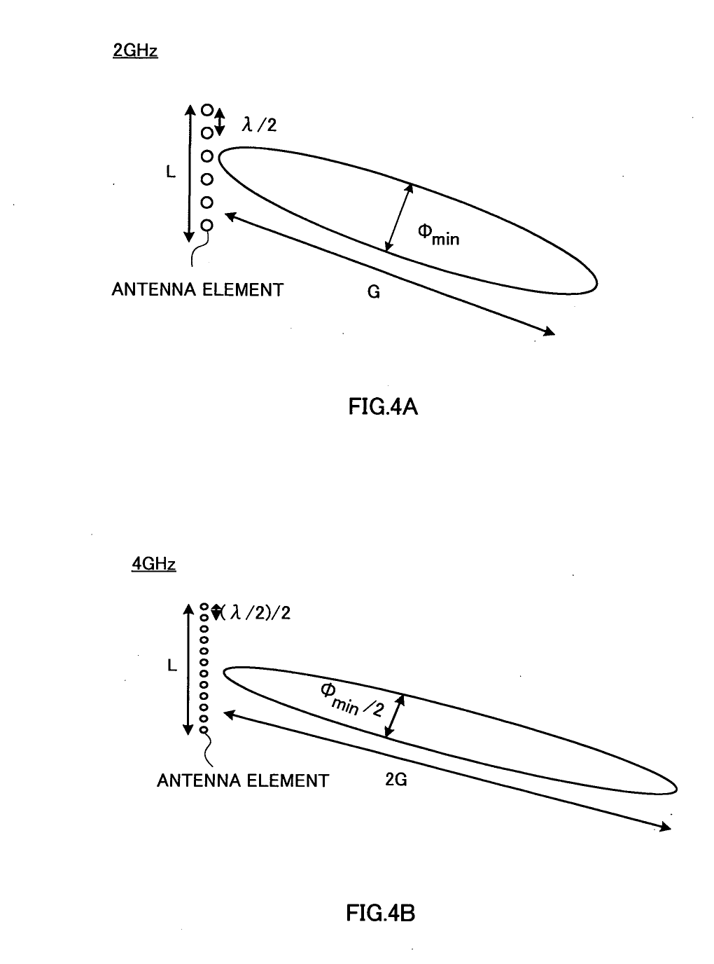

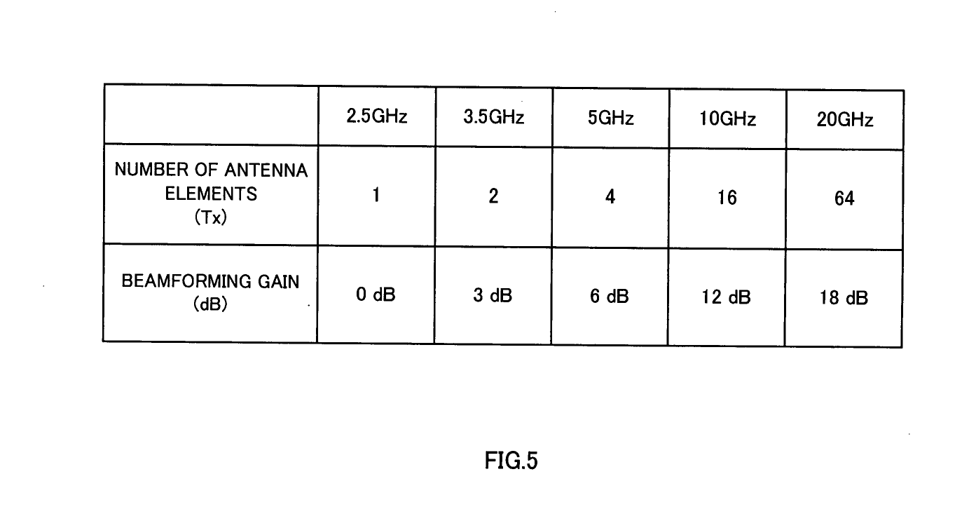

Now, the relationship between frequency f and the number of antenna elements will be described with reference to FIG. 4 and FIG. 5. FIGS. 4 and 5 are diagrams to explain the relationship between frequency f and the number of antenna elements.

A case will be described here with FIG. 4 where antenna elements are aligned one-dimensionally. If antenna elements are arranged one-dimensionally, the number of antenna elements Tx that can be arranged over the antenna length L increases in proportion to the rate of increase of frequency f. For example, assume that, as shown in FIG. 4A, six antenna elements are aligned over the antenna length L when frequency f is 2 GHz. In this case, as shown in FIG. 4B, when frequency f becomes 4 GHz (twice that of FIG. 4A), it becomes possible to arrange twelve (=6×2) antenna elements over the same antenna length L.

Also, when antenna elements are arranged one-dimensionally, as the number of antenna elements Tx that can be arranged over the antenna length L increases, the beamforming gain also increases. For example, as shown in FIG. 4B, the number of antenna elements Tx that can be arranged over the antenna length L becomes twice that of FIG. 4A, the intervals between the antenna elements (hereinafter “antenna element intervals”) become ½ of FIG. 4A. When the antenna element intervals are narrower, the beam width becomes narrower, so that the beamforming gain increases. Consequently, the beamforming gain of FIG. 4B becomes twice that of FIG. 4A.

Now, by contrast, a case will be described here with FIG. 5 where antenna elements are arranged on a two-dimensional plane (when massive MIMO is applied). When antenna elements are arranged two-dimensionally, the number of antenna elements Tx that can be arranged in a predetermined area increases in square proportion to the rate of increase of frequency f. For example, as shown in FIG. 5, when frequency f is 2.5 GHz, one antenna element is arranged on a predetermined two-dimensional plane. In this case, when frequency f becomes 3.5 GHz, which is 1.4 times 2.5 GHz, the number of antenna elements Tx becomes 1.4²=1.9≈2. Also, when frequency f becomes 5 GHz, which is twice 2.5 GHz, the number of antenna elements Tx becomes 2²=4. When frequency f becomes 10 GHz, which is four times 2.5 GHz, or becomes 20 GHz, which is eight times 2.5 GHz, the number of antenna elements Tx becomes 4²=16 or 8²=64.

Also, when antenna elements are arranged two-dimensionally, as the number of antenna elements Tx that can be arranged in a predetermined area increases, the beamforming gain also increases, as shown in FIG. 5. That is, when massive MIMO is employed, the higher frequency f, the greater the beamforming gain that is achieved. Consequently, when massive MIMO is employed in the small cells, it is possible to compensate for the path loss of the high frequency band by means of the beamforming gain.

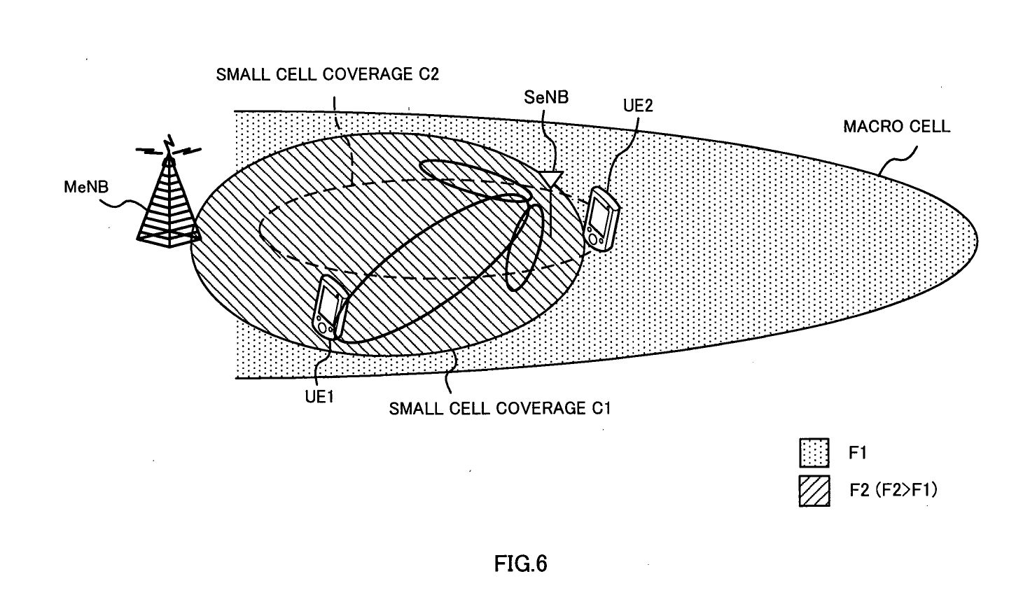

FIG. 6 is a diagram to explain small cell coverages. As shown in FIG. 6, the coverage C1 of the reference signals that are subject to beamforming expands in a predetermined direction, as seen in comparison with the coverage C2 of the reference signals that are not subject to beamforming. By this means, the user terminal 1, which is located in the beamforming direction, can receive the reference signals that are subject to beamforming, in predetermined received quality, even outside the coverage C2. On the other hand, there is a threat that the user terminal 2, located in the opposite direction of the beamforming direction, cannot receive the reference signals in sufficient received quality, even inside the coverage C2.

Also, in order to execute beamforming, it is necessary to acquire feedback information from the user terminals such as CSI (Channel State Information) to represent channel states, AOA (Angle of Arrival) and AOD (Angle of Departure), which are used to assign weights to the antenna elements, and so on. Consequently, in periods in which the feedback information, AOA, AOD and so on are not known, it may occur that beamforming cannot be executed, and the user terminals cannot receive the reference signals transmitted in these periods in sufficient received quality.

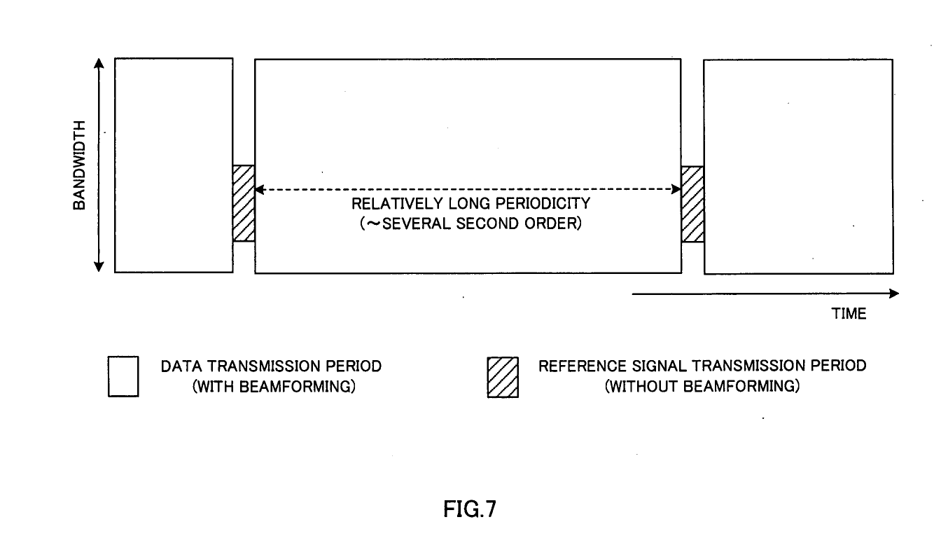

So, a method of improving the received quality of reference signals in user terminals without executing beamforming by means of massive MIMO is under study. To be more specific, as shown in FIG. 7, in reference signal transmission periods in which beamforming is not executed, a study is in progress to make the transmission bandwidth narrower than in data transmission periods in which beamforming is executed, and increase the transmit power.

For example, referring to FIG. 7, in proportion to the beamforming gain in the data transmission periods, the transmission bandwidth in the reference signal transmission periods is narrowed, and the transmit power is increased. By this means, even in the small cells where the carrier F2 of the high frequency band is used, it is possible to improve the received quality of reference signals in user terminals, without executing beamforming.

Now, it may occur that, in the small cells, downlink communication is carried out by using a plurality of antenna ports (antennas), so that it is desirable that user terminals measure the received quality of reference signals that vary per antenna port, and estimate the channel state of each antenna port. However, as shown in FIG. 7, trying to transmit a plurality of reference signals that vary per antenna port in reference signal transmission periods in which the transmission bandwidth is narrowed raises a threat of a decrease in the received quality of each antenna port's reference signals in the user terminals.

So, the present inventors have studied a reference signal transmission method, which, when a plurality of reference signals that vary per antenna port are transmitted in reference signal transmission periods in which the transmission bandwidth is narrowed, can improve the received quality of each antenna port's reference signals in user terminals, and arrived at the present invention.

With the reference signal transmission method according to the present invention, a small base station generates a plurality of reference signals that vary per antenna port, and, in a reference signal transmission period (first transmission period) in which beamforming is not executed, transmits the above plurality of reference signals in a transmission bandwidth that is narrower than in a data transmission period (second transmission period) in which beamforming is executed. Also, the small base station spreads and transmits each antenna port's reference signals in at least one of the time direction and the frequency direction.

Here, spreading in the time direction means mapping the reference signals of each antenna port to a plurality of time resources (for example, OFDM symbols and so on). Here, spreading in the frequency direction means mapping the reference signals of each antenna port to a plurality of frequency resources (for example, subcarriers, physical resource blocks (PRBs), PRB pairs and so on). Note that spreading in the time direction or in the frequency direction is also referred to as “one-dimension spreading.” Also, spreading in the time direction and in the frequency direction may be referred to as “two-dimension spreading.”

Also, a plurality of reference signals that vary per antenna port may be multiplexed upon the transmission bandwidth by at least one of frequency division multiplexing and code division multiplexing. In frequency division multiplexing, these plurality of reference signals are mapped to orthogonal frequency resources (for example, subcarriers, PRBs, PRB pairs and so on). Also, in code division multiplexing, these plurality of reference signals are multiplied by orthogonal codes (for example, OCCs: Orthogonal Cover Codes).

Also, a reference signal transmission period (first transmission period) refers to a period in which the reference signals are transmitted without executing beamforming. The reference signals, are, for example, the CRS (Cell-Specific Reference Signal), the CSI-RS (Channel State Information-Reference Signal), the DM-RS (DeModulation-Reference Signal), the discovery signal and so on, but are by no means limited to these, and have only to be signals for measuring received quality. Note that the received quality may include, for example, the RSRP (Reference Signal Received Power), the RSRQ (Reference Signal Received Quality), the SINR (Signal Interference Noise Ratio) and so on.

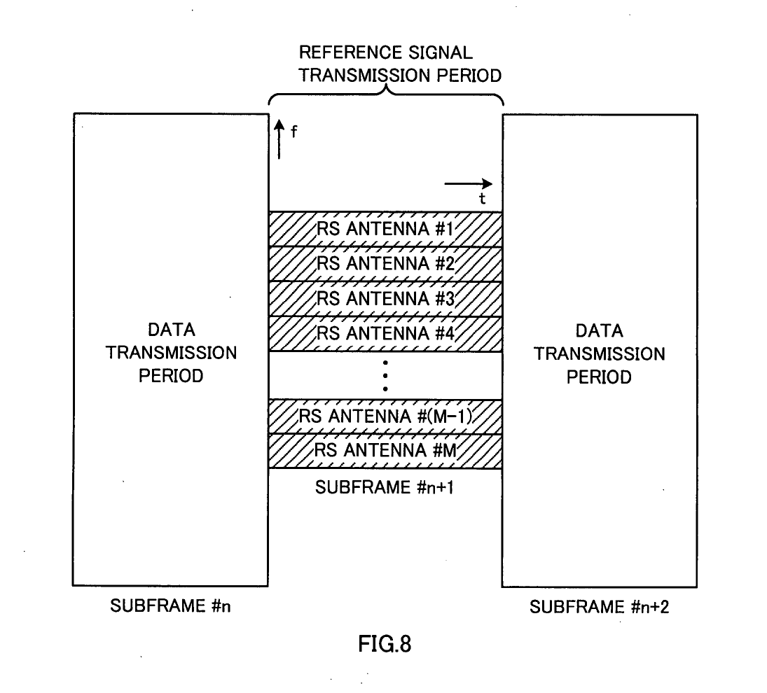

Also, in a reference signal transmission period, as shown in FIG. 8 and so on, the reference signals are transmitted by making the transmission bandwidth narrower than in a data transmission period (second transmission period) and increasing the transmit power. Consequently, even if beamforming gain cannot be achieved as in the data transmission period, it is still possible to prevent the decrease of the received quality of reference signals in user terminals. Note that the transmission bandwidth in the reference signal transmission period may be determined based on the beamforming gain in the data transmission period, the number of antenna elements and so on.

Meanwhile, a data transmission period (second transmission period) refers to a period to execute beamforming and transmit user data and higher layer control information, which are transmitted in the data signal (for example, PDSCH (Physical Downlink Shared Channel)). In the data transmission period, the decrease of received quality in user terminals can be prevented by means of beamforming gain.

Note that, in a reference signal transmission period, not only the reference signals, but also non-user-specific downlink signals such as downlink control signals (for example, shared control information that is transmitted in the PDCCH (Physical Downlink Control Channel)) and so on may be transmitted as well. Also, in a data transmission period, not only the data signal, but also user-specific downlink signals such as L1/L2 signals, downlink control signals (for example, dedicated control information that is transmitted in the PDCCH) and so on may be transmitted as well.

Now, reference signal transmission methods according to examples 1 to 4 of the present invention will be described below in detail.

### Example 1

Reference signal transmission methods according to example 1 of the present invention will be described with reference to FIGS. 8 to 12. With the reference signal transmission methods according to example 1, a small base station frequency-division-multiplexes a plurality of reference signals that vary per antenna port, and spreads the reference signals of each antenna port in the time direction (one-dimension spreading). Here, the reference signals of each antenna port may be spread in one subframe (example 1.1), or may be spread over a plurality of subframes (example 1.2). Also, a user terminal performs in-phase addition of the reference signals of each antenna port that are spread in the time direction, and measures the received quality of each antenna port's reference signals.

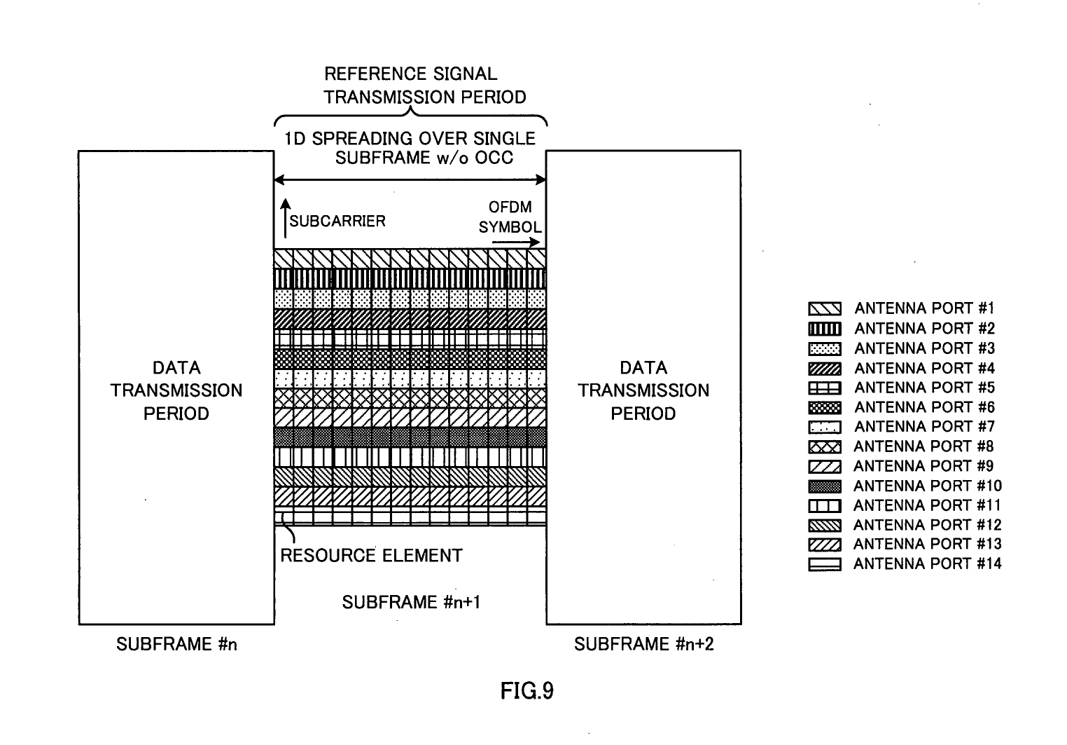

FIGS. 8 and 9 are diagrams to explain the reference signal transmission method according to example 1.1. Note that, in FIGS. 8 and 9, subframe #n+1 is a reference signal transmission period, and subframes #n and #n+2 are data transmission periods. Referring to FIG. 8, in subframe #n+1, a small base station transmits the reference signals of M (M≧2) antenna ports #1 to #M in a transmission bandwidth that is narrower than in subframes #n and #n+2.

Also, referring to FIG. 8, the small base station maps the reference signals of antenna ports #1 to #M to mutually orthogonal frequency resources (for example, subcarriers, PRBs, PRB pairs and so on), and frequency-division-multiplexes the reference signals. Also, the small base station spreads each of the reference signals of antenna ports #1 to #M in the time direction, in one subframe #n+1.

For example, as shown in FIG. 9, when the number of antenna ports is fourteen, the small base station maps the reference signals of antenna ports #1 to #14 to mutually varying subcarriers, respectively. Also, the small base station maps the reference signals of antenna ports #1 to #14 to a plurality of OFDM symbols in one subframe #n+1, respectively, and spreads the reference signals in the time direction. Note that, although, in FIG. 9, the reference signals of antenna ports #1 to #14 are mapped to all the OFDM symbols in subframe #n+1, respectively, these reference signals do not have to be mapped to all of the OFDM symbols.

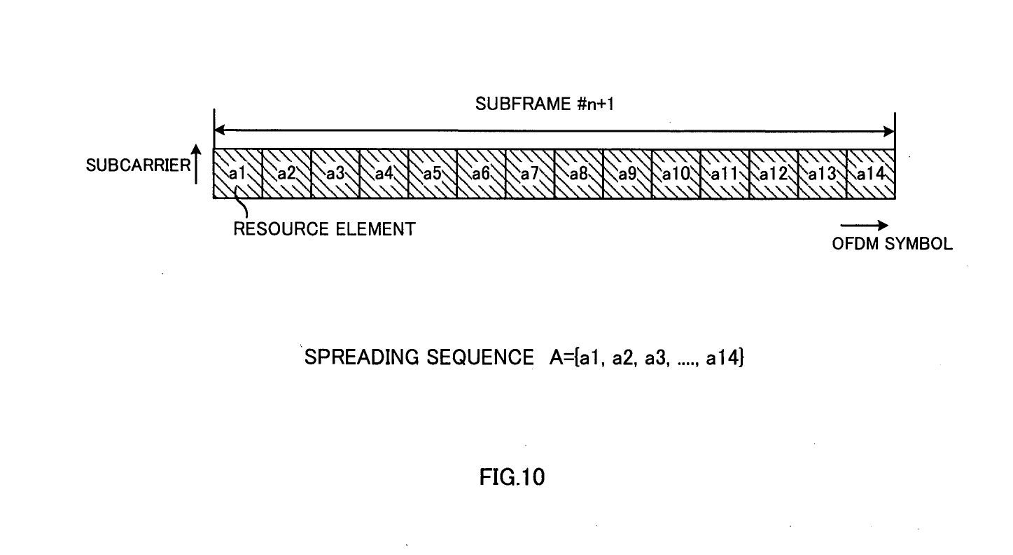

FIG. 10 is a diagram to show an example of spreading of the reference signals of antenna port #1. As has been described with FIG. 9, when the reference signals of antenna port #1 are spread over all of the fourteen OFDM symbols of subframe #n+1, the spreading sequence for the reference signals of antenna port #1 can be represented by A={a1, a2, a3, a14}. In this case, as shown in FIG. 10, the reference signals a1, . . . , a14 of antenna port #1 are mapped to the subcarrier for antenna port #1 and the resource elements represented by the first to fourteenth OFDM symbols of subframe #n+1.

Also, in the reference signal transmission method according to example 1.1, the user terminal adds up, in-phase, the reference signals of each antenna port that are mapped to a plurality of OFDM symbols in one subframe #n+1 (see FIG. 9), and measure the received quality of each antenna port's reference signals.

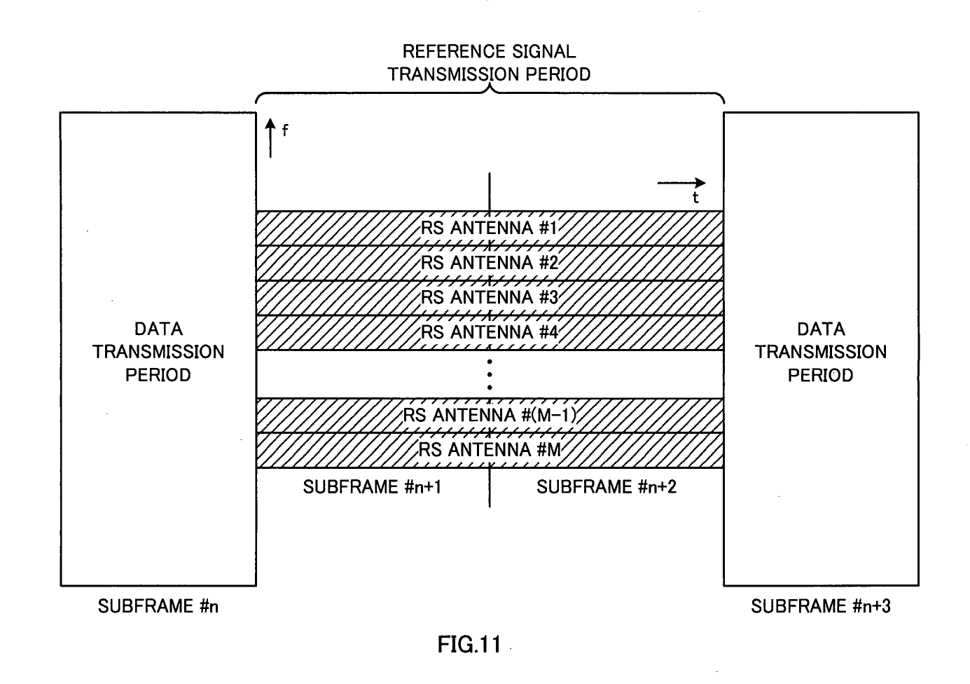

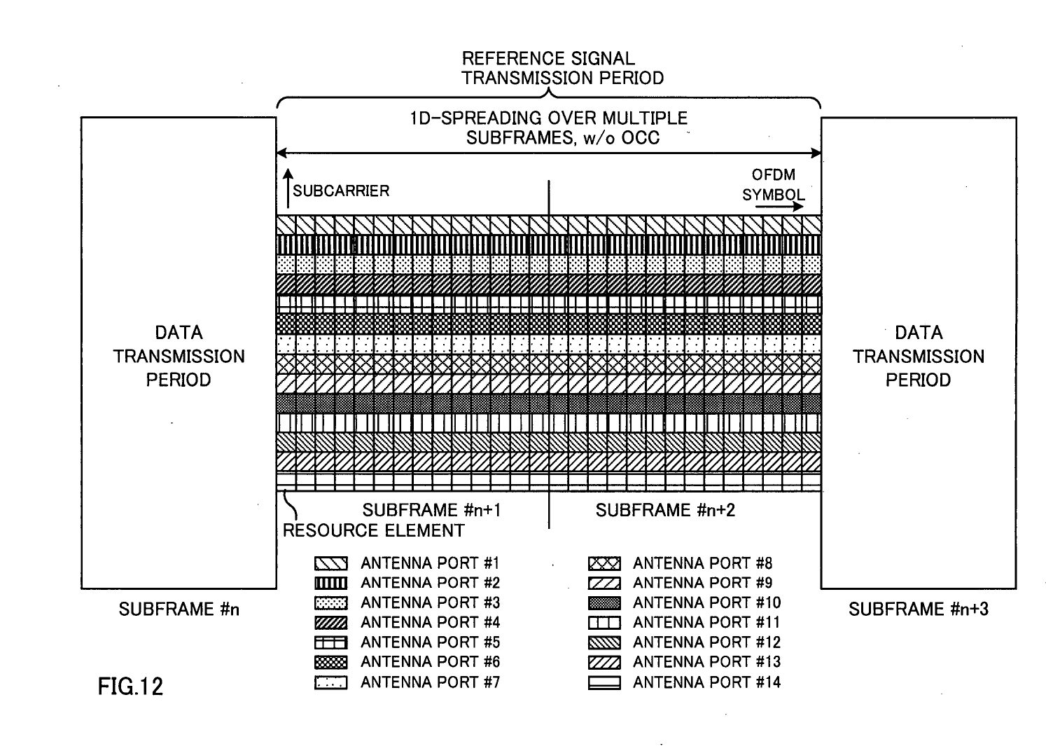

FIGS. 11 and 12 are diagrams to explain the reference signal transmission method according to example 1.2. Note that, in FIGS. 11 and 12, consecutive subframes #n+1 and #n+2 are reference signal transmission periods, and subframes #n and #n+3 are data transmission periods. In FIG. 11, in subframes #n+1 and #n+2, the small base station transmits the reference signals of M (M□2) antenna ports #1 to #M in a transmission bandwidth that is narrower than in subframes #n and #n+3.

Also, in FIG. 11, the small base station maps the reference signals of antenna ports #1 to #M to mutually orthogonal frequency resources (for example, subcarriers, PRBs, PRB pairs and so on), and frequency-division-multiplexes the reference signals. Also, the small base station spreads each of the reference signals of antenna ports #1 to #M in the time direction, over two subframes #n+1 and #n+2. Note that the number of subframes where the reference signals are spread may be greater than two. Also, a plurality of subframes where the reference signals are spread do not have to be consecutive.

For example, as shown in FIG. 12, when the number of antenna ports is fourteen, the small base station maps the reference signals of antenna ports #1 to #14 to mutually varying subcarriers. Also, the small base station maps the reference signals of antenna ports #1 to #14 to a plurality of OFDM symbols that stretch over a plurality of subframes #n+1 and #n+2, respectively, and spreads the reference signals in the time direction. Note that, although, in FIG. 12, the reference signals of antenna ports #1 to #14 are mapped to all the OFDM symbols that stretch over two subframes #n+1 and #n+2, respectively, these reference signals do not have to be mapped to all of the OFDM symbols.

Also, in the reference signal transmission method according to example 1.2, the user terminal adds up, in-phase, the reference signals of each antenna port that are mapped to a plurality of OFDM symbols stretching over a plurality of subframes #n+1 and #n+2 (see FIG. 12), and measures the received quality of each antenna port's reference signals.

With the reference signal transmission methods according to example 1, a plurality of reference signals that vary per antenna port are frequency-division-multiplexed, and the reference signals of each antenna port are spread in the time direction and transmitted. Consequently, the user terminal can add up, in-phase, the reference signals of each antenna port that are spread in the time direction, and measure the received quality. As a result of this, it is possible to improve the received quality of each antenna port's reference signals in the user terminal. In particular, with the reference signal transmission method according to example 1.2, the reference signals of each antenna port are spread over a plurality of subframes, so that it is possible to enhance the effect of improving the received quality of each antenna port's reference signals, and, furthermore, increase the transmit power of the reference signals and expand the coverage.

### Example 2

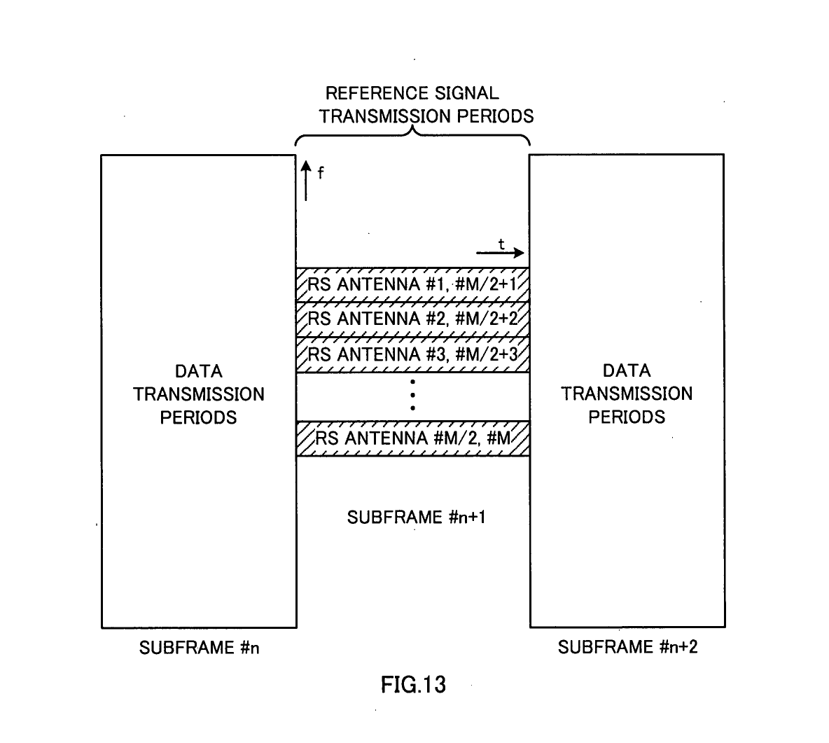

Reference signal transmission methods according to example 2 of the present invention will be described with reference to FIGS. 13 to 16. The reference signal transmission methods according to example 2 are different from example 1 in that the small base station frequency-division-multiplexes and code-division-multiplexes a plurality of reference signals that vary per antenna port.

In the reference signal transmission methods according to example 2, the reference signals of each antenna port are spread in the time direction (one-dimension spreading), as in example 1. Here, the reference signals of each antenna port may be spread in one subframe (example 2.1), or may be spread over a plurality of subframes (example 2.2). Also, as in example 1, the user terminal adds up, in-phase, the reference signals of each antenna port that are spread in the time direction, and measures the received quality of each antenna port's reference signals. Now, differences from example 1 will be primarily described below.

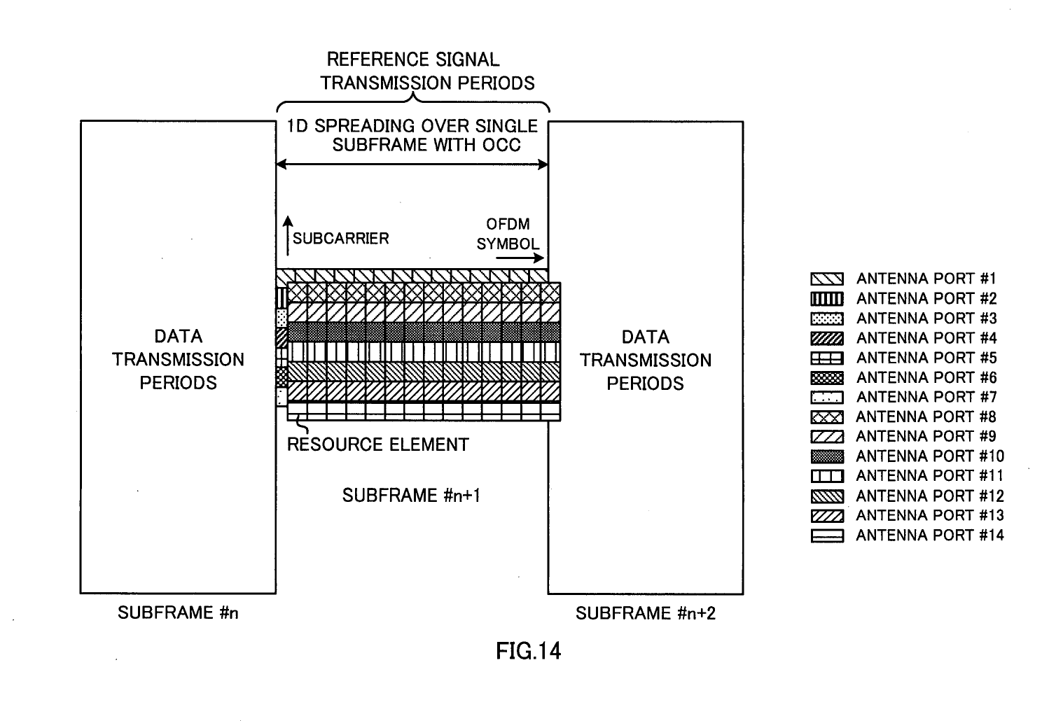

FIGS. 13 and 14 are diagrams to explain the reference signal transmission method according to example 2.1. Note that, in FIGS. 13 and 14, subframe #n+1 is a reference signal transmission period, and subframes #n and #n+2 are data transmission periods. Referring to FIG. 13, in subframe #n+1, the small base station transmits the reference signals of M (M□2) antenna ports #1 to #M, in a transmission bandwidth that is narrower than in subframes #n and #n+2.

Also, in FIG. 13, the small base station multiplies the reference signals of varying antenna ports by orthogonal codes (for example, OCCs), and code-division-multiplexes the reference signals over the same frequency/time resources (for example, resource elements, PRBs, PRB pairs and so on). For example, in FIG. 13, the small base station multiplies the reference signals of antenna port #1 and the reference signals of antenna port #M/2+1 by orthogonal codes, and maps these reference signals to the same frequency/time resources. The same applies to the reference signals of antenna ports #2 to #M/2 and the reference signals of antenna ports #M/2+1 to #M.

Also, the small base station maps each of a plurality of reference signals to be code-division-multiplexed to orthogonal frequency resources, and frequency-division-multiplexes the reference signals. For example, referring to FIG. 13, the small base station maps the reference signals of antenna ports #1 to #M/2 to mutually orthogonal frequency resources. Also, the small base station maps the reference signals of antenna ports #1 to #M/2 and the reference signals of antenna ports #M/2+1 to #M, which are code-division-multiplexed, to orthogonal frequency resources, respectively.

In this way, in FIG. 13, the small base station code-division-multiplexes and frequency-division-multiplexes reference signals that vary per antenna port. Also, the small base station spreads each of the reference signals of antenna ports #1 to #M in the time direction in one subframe #n+1.

For example, as shown in FIG. 14, when the number of antenna ports is fourteen, the small base station maps the reference signals of antenna ports #1 and #8 to be code-division-multiplexed to a plurality of OFDM symbols in subframe #n+1, and spreads the reference signals in the time direction. The same applies to the reference signals of antenna ports #2 to #7 and #9 to #14. Note that, although, in FIG. 14, the reference signals of antenna ports #1 to #14 are mapped to all of the OFDM symbols in subframe #n+1, respectively, these reference signals do not have to be mapped to all the OFDM symbols.

Also, in the reference signal transmission method according to example 2.1, the user terminal adds up, in-phase, the reference signals of each antenna port that are mapped to a plurality of OFDM symbols in one subframe #n+1 (see FIG. 14), and measures the received quality of each antenna port's reference signals.

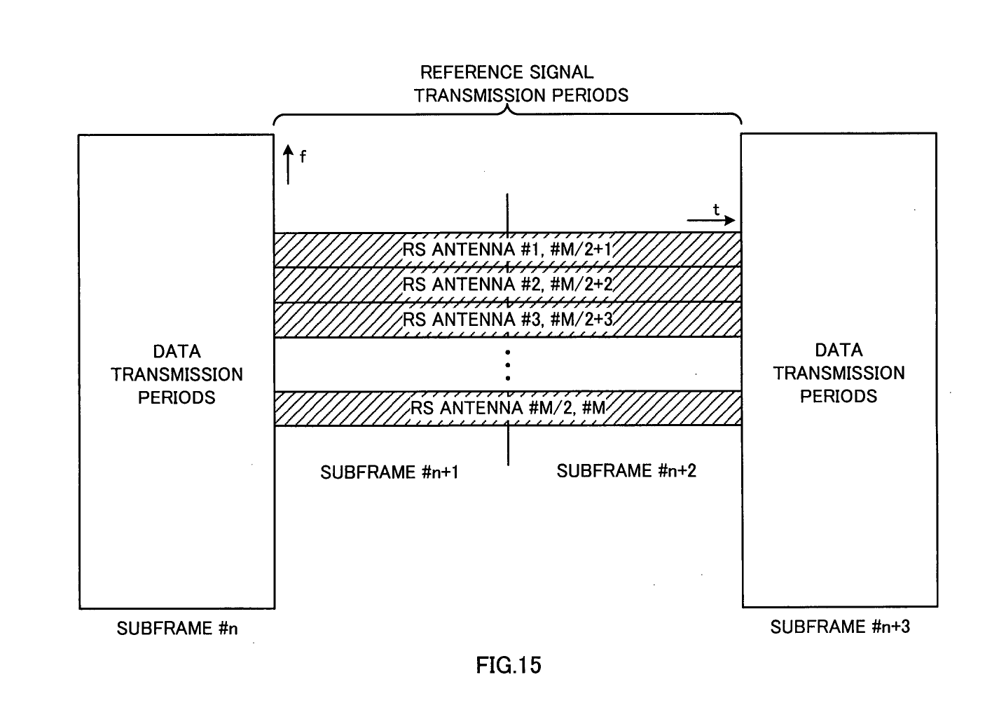

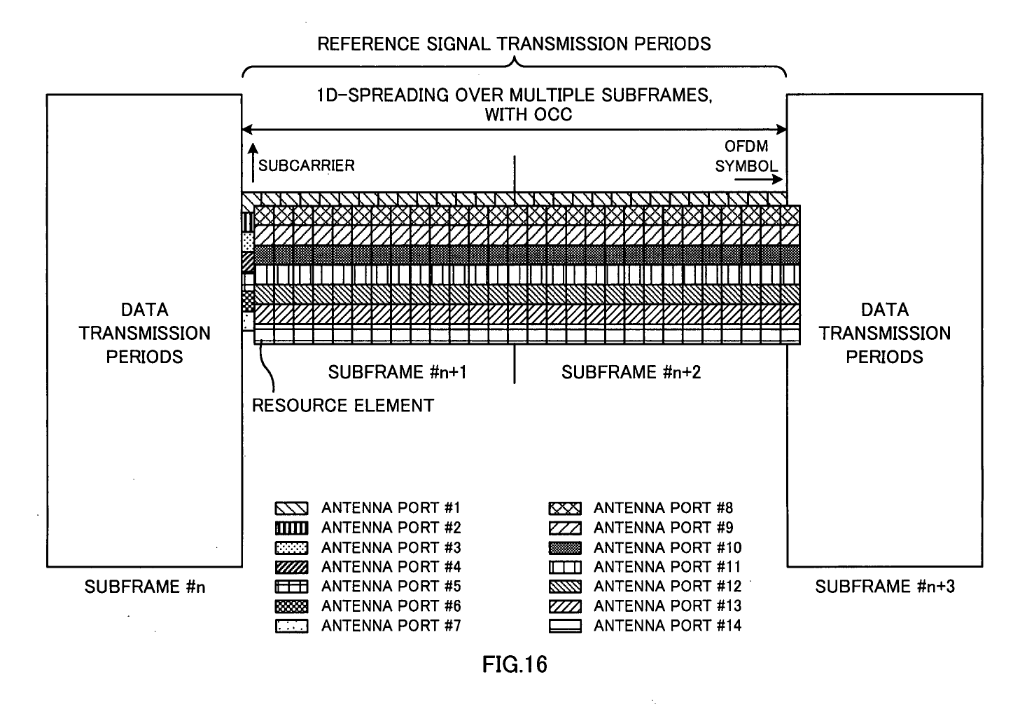

FIGS. 15 and 16 are diagrams to explain the reference signal transmission method according to example 2.2. Note that, in FIGS. 15 and 16, consecutive subframes #n+1 and #n+2 are reference signal transmission periods, and subframes #n and #n+3 are data transmission periods. In FIG. 15, the small base station code-division-multiplexes and frequency-division-multiplexes reference signals that vary per antenna port, as in FIG. 13. Also, the small base station spreads each of the reference signals of antenna ports #1 to #M in the time direction, over a plurality of subframes #n+1 and #n+2. Note that the number of subframes where the reference signals are spread may be greater than two. Also, a plurality of subframes where the reference signals are spread do not have to be consecutive.

For example, as shown in FIG. 16, when the number of antenna ports is fourteen, the small base station maps the reference signals of antenna ports #1 and #8 to be code-division-multiplexed, to a plurality of OFDM symbols that stretch over a plurality of subframes #n+1 and #n+2, and spreads the reference signals in the time direction. The same applies to the reference signals of antenna ports #2 to #7 and #9 to #14. Note that, although, in FIG. 16, the reference signals of antenna ports #2 to #7 and #9 to #14 are mapped to all of the OFDM symbols that stretch over two subframes #n+1 and #n+2, respectively, these reference signals do not have to be mapped to all the OFDM symbols.

Also, with the reference signal transmission method according to example 2.2, the user terminal adds up, in-phase, the reference signals of each antenna port that are mapped to a plurality of OFDM symbols stretching over a plurality of subframes #n+1 and n+2 (see FIG. 16), and measures the received quality of each antenna port's reference signals.

With the reference signal transmission methods according to example 2, a plurality of reference signals that vary per antenna are not only frequency-division-multiplexed, but are also code-division-multiplexed, so that it is possible to improve the efficiency of the use of frequency resources. Also, since the reference signals of each antenna port are spread in the time direction and transmitted, it is possible to improve the received quality of each antenna port's reference signals in user terminals. In particular, with the reference signal transmission method according to example 2.2, the reference signals of each antenna port are spread over a plurality of subframes, so that it is possible to enhance the effect of improving the received quality of each antenna port's reference signals, and, furthermore, increase the transmit power of the reference signals and expand the coverage.

### Example 3

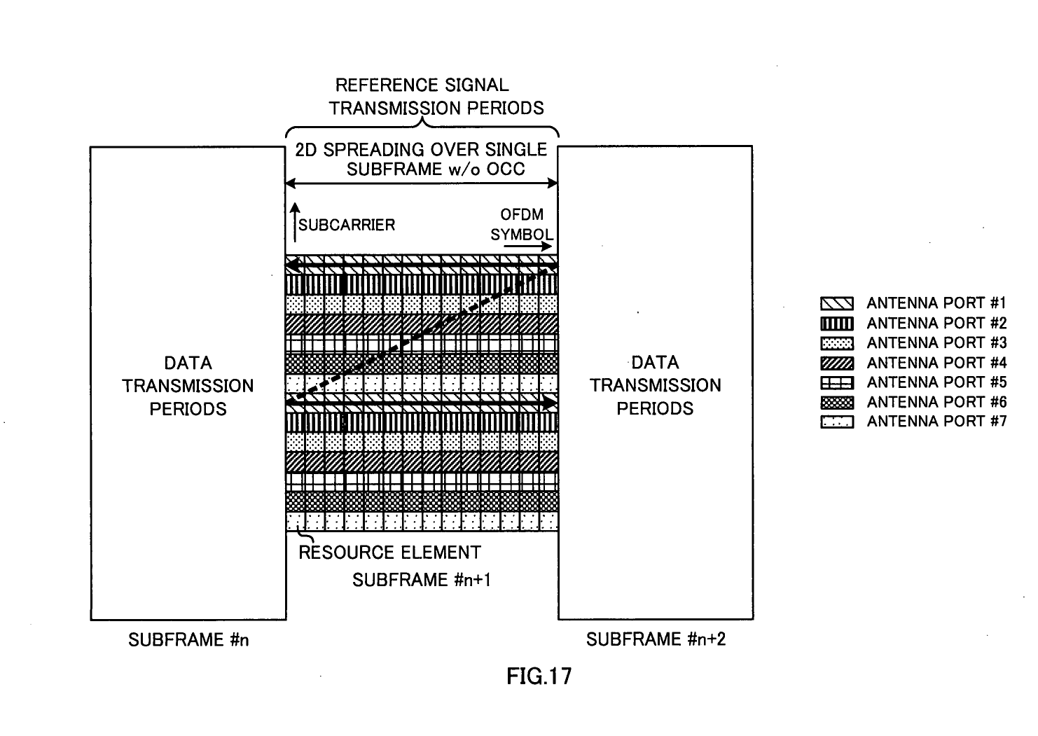

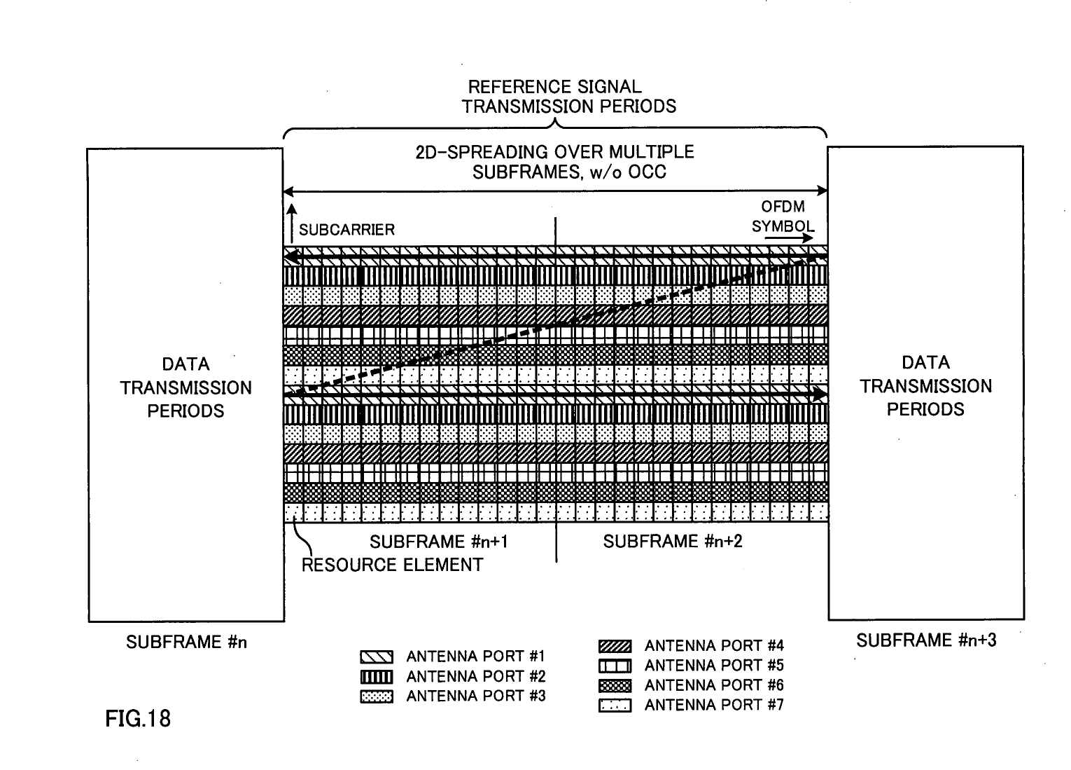

Reference signal transmission methods according to example 3 of the present invention will be described with reference to FIGS. 17 and 18. The reference signal transmission methods according to example 3 are different from example 1 in that the small base station spreads the reference signals of each antenna port in the time direction and in the frequency direction (two-dimension spreading). Here, the reference signals of each antenna port may be spread in one subframe (example 3.1), or may be spread over a plurality of subframes (example 3.2). Note that the small base station frequency-division-multiplexes a plurality of reference signals that vary per antenna port, as in example 1.

Also, in the reference signal transmission methods according to example 3, the user terminal adds up, in-phase, the reference signals of each antenna port that are spread in the time direction and in the frequency direction, and measures the received quality of each antenna port's reference signals. Now, differences from example 1 will be primarily described below.

FIG. 17 is a diagram to explain the reference signal transmission method according to example 3.1. Note that, in FIG. 17, subframe #n+1 is a reference signal transmission period, and subframes #n and #n+2 are data transmission periods. In FIG. 17, in subframe #n+1, the small base station transmits the reference signals of seven antenna ports #1 to #7 in a transmission bandwidth that is narrower than in subframes #n and #n+2. Note that the number of antenna ports is not limited to seven.

Also, in FIG. 17, the small base station maps the reference signals of antenna ports #1 to #7 to mutually orthogonal frequency resources (for example, subcarriers), respectively, and frequency-division-multiplexes the reference signals. Also, the small base station spreads each of the reference signals of antenna ports #1 to #7 in the time direction and in the frequency direction in one subframe #n+1.

To be more specific, as shown in FIG. 17, the small base station maps the reference signals of antenna port #1 to a plurality of subcarriers, and spreads the reference signals in the frequency direction. Similarly, the small base station spreads the reference signals of antenna ports #2 to #7 to a plurality of subcarriers, and spreads the reference signals in the frequency direction. Note that, although, in FIG. 17, the reference signals of each antenna port are spread over two subcarriers, the number of subcarriers is not limited to two. Also, although the reference signals of each antenna port are spread over a plurality of non-consecutive subcarriers, they may be spread over a plurality of consecutive subcarriers as well.

Also, the small base station maps the reference signals of antenna ports #1 to #7, which are spread in the frequency direction, to a plurality of OFDM symbols in one subframe #n+1, respectively, and spreads the reference signals in the time direction. Note that, although, in FIG. 17, the reference signals of antenna ports #1 to #7 are mapped to all of the OFDM symbols in subframe #n+1, respectively, these reference signals do not have to be mapped to all the OFDM symbols.

Also, in the reference signal transmission method according to example 3.1, the user terminal adds up, in-phase, the reference signals of each antenna port that are mapped to a plurality of OFDM symbols in a plurality of subcarriers in one subframe #n+1 (see FIG. 17), and measures the received quality of each antenna port's reference signals.

FIG. 18 is a diagram to explain the reference signal transmission method according to example 3.2. Note that, in FIG. 18, consecutive subframes #n+1 and #n+2 are reference signal transmission periods, and subframes #n and #n+3 are data transmission periods. In FIG. 18, as in FIG. 17, the small base station frequency-division-multiplexes the reference signals that vary per antenna port.

Also, in FIG. 18, the small base station maps the reference signals of antenna ports #1 to #7 to mutually orthogonal frequency resources (for example, subcarriers), respectively, and frequency-division-multiplexes the reference signals. Also, the small base station spreads each of the reference signals of antenna ports #1 to #7 in the time direction and in the frequency direction, over a plurality of subframe #n+1 and #n+2. Note that the number of subframes where the reference signals are spread may be greater than two. Also, a plurality of subframes where the reference signals are spread do not have to be consecutive.

To be more specific, as shown in FIG. 18, the small base station maps the reference signals of antenna port #1 to a plurality of subcarriers, and spreads the reference signals in the frequency direction. Similarly, the small base station maps the reference signals of antenna ports #2 to #7 to a plurality of subcarriers, and spreads the reference signals in the frequency direction. Note that, although, in FIG. 18, the reference signals of each antenna port are spread over two subcarriers, the number of subcarriers is not limited to two. Also, although the reference signals of each antenna port are spread over a plurality of non-consecutive subcarriers, these reference signals may be spread over a plurality of consecutive subcarriers as well.

Also, the small base station maps the reference signals of antenna ports #1 to #7, which are spread in the frequency direction, to a plurality of OFDM symbols that stretch over a plurality of subframes #n+1 and #n+2, respectively, and spreads the reference signals in the time direction. Note that, although, in FIG. 18, the reference signals of antenna ports #1 to #7 are mapped to all of the OFDM symbols that stretch over a plurality of subframe #n+1 and #n+2, respectively, these reference signals do not have to be mapped to all the OFDM symbols.

Also, in the reference signal transmission method according to example 3.2, the user terminal adds up, in-phase, the reference signals of each antenna port that are mapped to a plurality of OFDM symbols of a plurality of subcarriers stretching over a plurality of subframe #n+1 and #n+2 (see FIG. 18), and measures the received quality of each antenna port's reference signals.

With the reference signal transmission methods according to example 3, a plurality of reference signals that vary per antenna port are frequency-division-multiplexed, and the reference signals of each antenna port are spread in the time direction and the frequency direction and transmitted. Consequently, it is possible to improve the received quality of each antenna port's reference signals in user terminals. In particular, with the reference signal transmission method according to example 3.2, the reference signals of each antenna port are spread over a plurality of subframes, so that it is possible to enhance the effect of improving the received quality of each antenna port's reference signals, and, furthermore, increase the transmit power of the reference signals and expand the coverage.

### Example 4

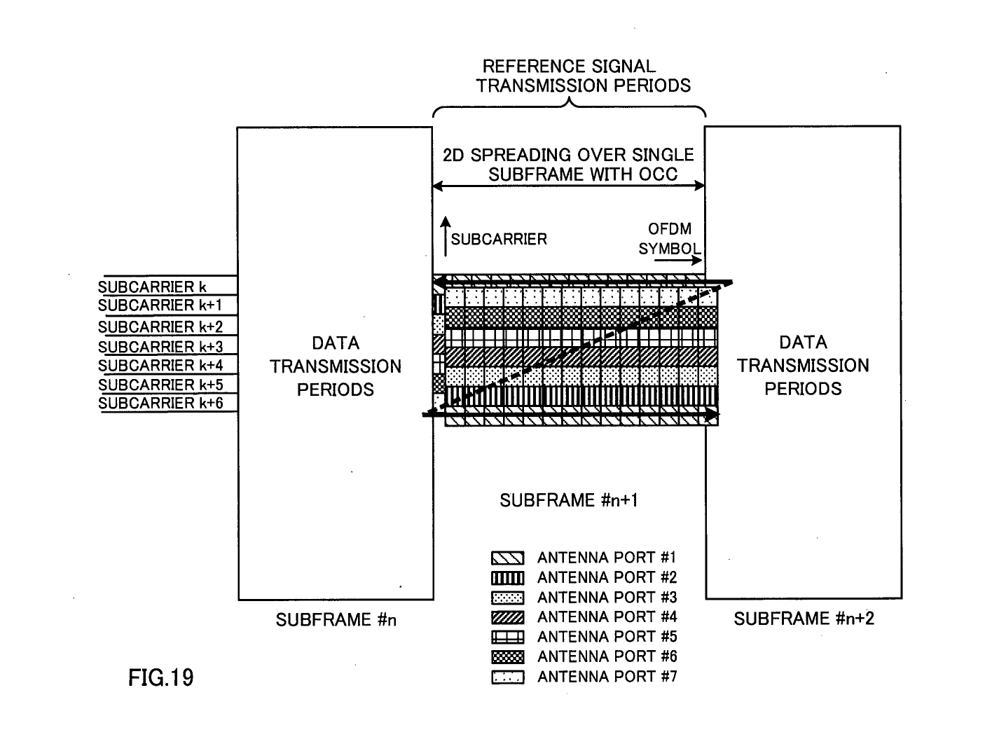

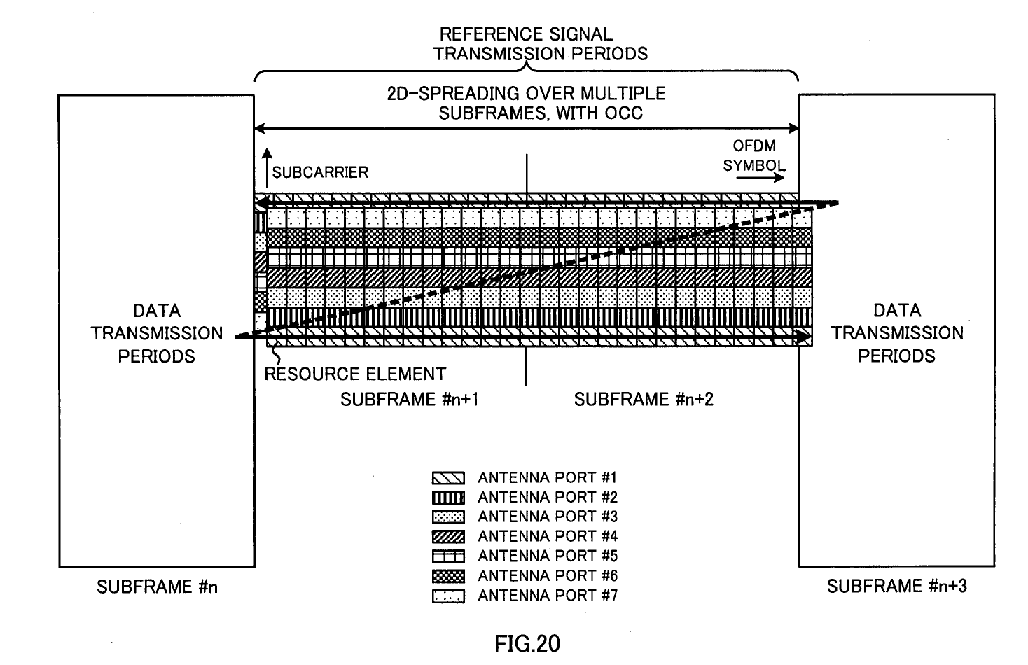

Reference signal transmission methods according to example 4 of the present invention will be described with reference to FIGS. 19 and 20. The reference signal transmission methods according to example 4 are different from example 3 in that the small base station frequency-division-multiplexes and code-division-multiplexes a plurality of reference signals that vary per antenna port.

In the reference signal transmission methods according to example 4, the reference signals of each antenna port are spread in the time direction and in the frequency direction (two-dimension spreading), as in example 3. Here, the reference signals of each antenna port may be spread in one subframe (example 4.1), or may be spread over a plurality of subframes (example 4.2). Also, the user terminal adds up, in-phase, the reference signals of each antenna port that are spread in the time direction and the frequency direction, and measures the received quality of each antenna port's reference signals. Note that differences from example 3 will be primarily described below.

Note that, in the reference signal transmission methods according to example 4, as will be described with reference to FIG. 19, the reference signals of each antenna port may be spread using a plurality of code resources (for example, orthogonal codes).

FIG. 19 is a diagram to explain the reference signal transmission method according to example 4.1. Note that, in FIG. 19, subframe #n+1 is a reference signal transmission period, and subframes #n and #n+2 are data transmission periods. In FIG. 19, in subframe #n+1, the small base station transmits the reference signals of seven antenna ports #1 to #7 in a transmission bandwidth that is narrower than in subframes #n and #n+2. Note that the number of antenna ports is not limited to seven.

Referring to FIG. 19, the small base station multiplies the reference signals of antenna ports #1 and #7 by orthogonal codes, maps the reference signals to the same frequency resources (for example, subcarriers #k and #k+6), and code-division-multiplexes the reference signals. Similarly, the small base station multiplies each of the reference signals of antenna ports #2 and #6 and the reference signals of antenna ports #3 and #5 by orthogonal codes, and maps the reference signals to the same frequency resources. Note that the number of antenna ports to be code-division-multiplexed over the same frequency resources may be greater than two.

Also, in FIG. 19, the small base station maps the reference signals of antenna ports #1 to #7 to mutually orthogonal frequency resources (for example, subcarrier #k to #k+6), respectively, and frequency-division-multiplexes the reference signals. Also, the small base station spreads each of the reference signals of antenna ports #1 to #7 in the time direction and the frequency direction in one subframe #n+1.

For example, in FIG. 19, the small base station maps the reference signals of antenna port #1 to subcarriers #1 and #k+6, and spreads the reference signals in the frequency direction. Also, the small base station maps the reference signals of antenna port #7 to subcarriers #k+6 and #1, and spreads the reference signals in the frequency direction. The same applies to the reference signals of antenna ports #2, #3, #5 and #6. Note that the number of subcarriers where the reference signals of each antenna port are mapped may be greater than two. Also, although, in FIG. 19, the reference signals of each antenna port are mapped to a plurality of non-consecutive subcarriers, these reference signals may be mapped to a plurality of consecutive subcarriers as well.

Here, the reference signals of antenna port #4 of FIG. 19 are mapped only to subcarrier #4, and spread by means of orthogonal codes. Consequently, FIG. 19 may be construed such that the reference signals of antenna port #4 are spread in the time direction and also are spread by using orthogonal codes.

Also, the small base station maps the reference signals of antenna ports #1 to #7 to a plurality of OFDM symbols in one subframe #n+1, respectively, and spreads the reference signals in the time direction. Note that, although, in FIG. 19, the reference signals of antenna ports #1 to #7 are mapped to all of the OFDM symbols in subframe #n+1, respectively, these reference signals do not have to be mapped to all the OFDM symbols.

Also, in the reference signal transmission method according to example 4.1, the user terminal adds up, in-phase, the reference signals of each antenna port that are mapped to a plurality of OFDM symbols of at least one subcarrier in one subframe #n+1 (see FIG. 19), and measures the received quality of each antenna port's reference signals.

FIG. 20 is a diagram to explain the reference signal transmission method according to example 4.2. Note that, in FIG. 20, consecutive subframes #n+1 and #n+2 are reference signal transmission periods, and subframes #n and #n+3 are data transmission periods. In FIG. 20, the small base station frequency-division-multiplexes and code-division-multiplexes reference signals that vary per antenna port, as in FIG. 19.

Also, referring to FIG. 20, the small base station spreads each of the reference signals of antenna ports #1 to #7 in the time direction, over a plurality of subframes #n+1 and #n+2. Note that the number of subframes where the reference signals are spread may be greater than two. Also, as has been described with reference to FIG. 19, the small base station spreads the reference signals of antenna ports #1 to #3 and #5 to #7 in the frequency direction, and spreads the reference signals of antenna port #4 by means of orthogonal codes.

Note that the spreading over a plurality of subframe #n+1 and n+2 shown in FIG. 20 is the same as that of FIG. 18 and so on, and therefore its description will be omitted. In the reference signal transmission method according to example 4.2, the user terminal adds up, in-phase, the reference signals of each antenna port that are mapped to a plurality of OFDM symbols of at least one subcarrier to stretch over a plurality of subframes #n+1 and #n+2 (see FIG. 20), and measures the received quality of each antenna port's reference signals.

With the reference signal transmission methods according to example 4, a plurality of reference signals that vary per antenna port are not only frequency-division-multiplexed, but are also code-division-multiplexed, so that it is possible to improve the efficiency of the use of frequency resources. Also, since the reference signals of each antenna port are spread in the time direction and the frequency direction, it is possible to improve the received quality of each antenna port's reference signals in user terminals. In particular, with the reference signal transmission method according to example 4.2, the reference signals of each antenna port are spread over a plurality of subframes, so that it is possible to enhance the effect of improving the received quality of each antenna port's reference signals, and, furthermore, increase the transmit power of the reference signals and expand the coverage.

(Structure of Radio Communication System)

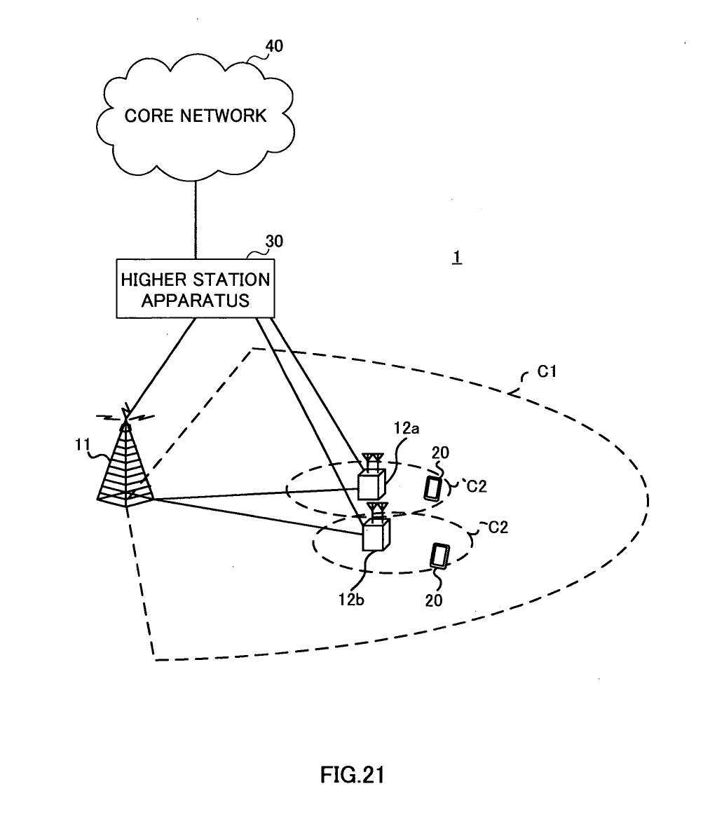

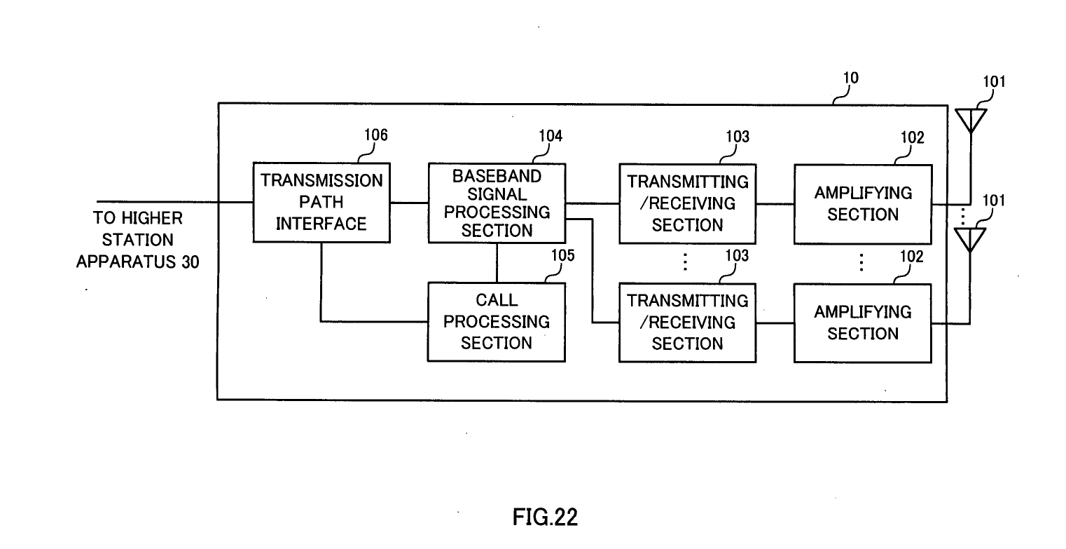

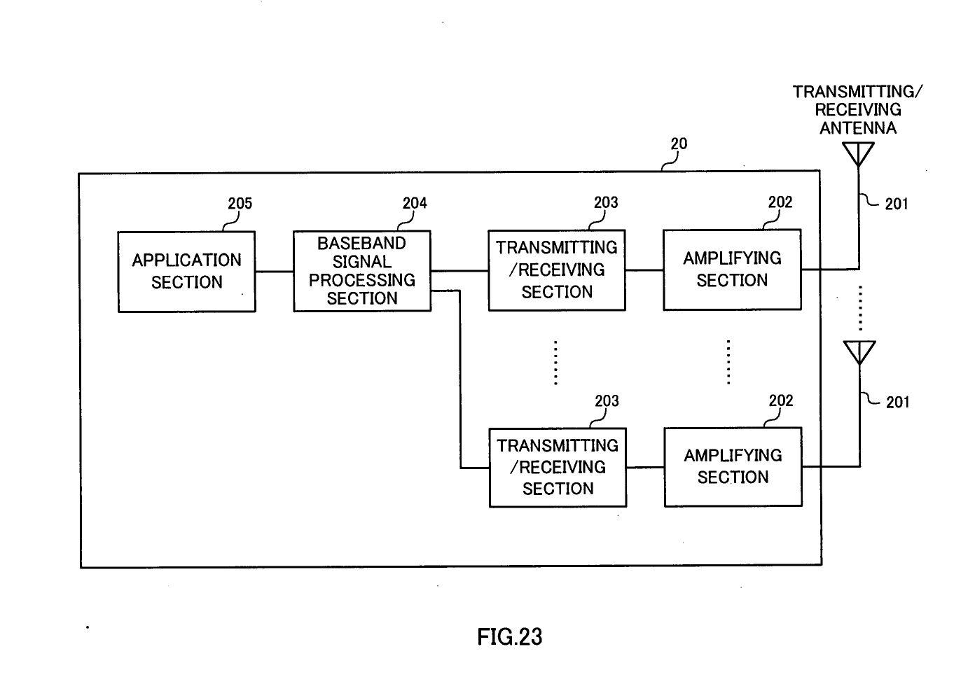

Now, the structure of the radio communication system according to the present embodiment will be described below. In this radio communication system, the above-described reference signal transmission methods (covering examples 1 to 4) are employed. A schematic structure of the radio communication system according to the present embodiment will be described with reference to FIGS. 21 to 25.

FIG. 21 is a diagram to show a schematic structure of a radio communication system according to the present embodiment. Note that the radio communication system shown in FIG. 21 is a system to accommodate, for example, the LTE system, the LTE-A system, IMT-Advanced, 4G, FRA (Future Radio Access) and so on.

As shown in FIG. 21, the radio communication system 1 includes a macro base station 11, which forms a macro cell C1, and small base stations 12a and 12b, which are placed in the macro cell C1 and which form small cells C2 that are narrower than the macro cell C1. Also, user terminals 20 are placed in the macro cell C1 and each small cell C2. The user terminals 20 are structured to be capable of carrying out radio communication with the macro base station 11 and both small base stations 12.

In the macro cell C1, for example, a carrier F1 of a relatively low frequency band such as, for example, 800 MHz and 2 GHz, is used. Meanwhile, in the small cells C2, a carrier F2 of a relatively high frequency band such as, for example, 3.5 GHz and 10 GHz, is used. Note that the carrier F1 may be referred to as an “existing carrier,” “legacy carrier,” “coverage carrier” and so on. Also, the carrier F2 nay be referred to as an “additional carrier,” “capacity carrier” and so on. Note that carriers of the same frequency band may be used in the macro cell C1 and the small cells C2.

The macro base station 11 and each small base station 12 may be connected via cable or may be connected by radio. The macro base station 11 and the small base stations 12 are each connected with a higher station apparatus 30, and are connected with a core network 40 via the higher station apparatus 30. Note that the higher station apparatus 30 may be, for example, an access gateway apparatus, a radio network controller (RNC), a mobility management entity (MME) and so on, but is by no means limited to these.

Note that the macro base station 11 is a radio base station having a relatively wide coverage, and may be referred to as an “eNodeB (eNB),” a “radio base station,” a “transmission point” and so on. The small base stations 12 are radio base stations that have local coverages, and may be referred to as “RRHs (Remote Radio Heads),” “pico base stations,” “femto base stations,” “Home eNodeBs,” “transmission points,” “eNodeBs (eNBs)” and so on. The user terminals 20 are terminals to support various communication schemes such as LTE and LTE-A, and may not only be mobile communication terminals, but may also be fixed communication terminals as well.

Also, in the radio communication system 1, as radio access schemes, OFDMA (Orthogonal Frequency Division Multiple Access) is applied to the downlink, and SC-FDMA (Single-Carrier Frequency Division Multiple Access) is applied to the uplink.

Also, in the radio communication system 1, a downlink shared channel (PDSCH: Physical Downlink Shared Channel), which is used by each user terminal 20 on a shared basis, downlink control channels (a PDCCH (Physical Downlink Control Channel), an EPDCCH (Enhanced Physical Downlink Control Channel), a PCFICH, a PHICH, a broadcast channel (PBCH), etc.), and so on are used as downlink communication channels. User data and higher layer control information are transmitted by the PDSCH. Downlink control information (DCI) is transmitted by the PDCCH and the EPDCCH.

Also, in the radio communication system 1, an uplink shared channel (PUSCH: Physical Uplink Shared Channel), which is used by each user terminal 20 on a shared basis, an uplink control channel (PUCCH: Physical Uplink Control Channel) and so on are used as uplink communication channels. User data and higher layer control information are transmitted by the PUSCH. Also, by means of the PUCCH, downlink radio quality information (CQI: Channel Quality Indicator), delivery acknowledgement information (ACKs/NACKs) and so on are transmitted.

Hereinafter, the macro base station 11 and the small base stations 12 will be collectively referred to as “radio base station 10,” unless distinction needs to be drawn otherwise. FIG. 19 is a diagram to show an overall structure of a radio base station 10 according to the present embodiment. The radio base station 10 has a plurality of transmitting/receiving antennas 101 (antenna ports) for MIMO transmission, amplifying sections 102, transmitting/receiving sections 103, a baseband signal processing section 104, a call processing section 105 and a transmission path interface 106. Note that a plurality of transmitting/receiving antennas 101 may be formed with antenna elements for massive MIMO.

User data to be transmitted from the radio base station 10 to a user terminal 20 on the downlink is input from the higher station apparatus 30, into the baseband signal processing section 104, via the transmission path interface 106.

In the baseband signal processing section 104, a PDCP layer process, division and coupling of the user data, RLC (Radio Link Control) layer transmission processes such as an RLC retransmission control transmission process, MAC (Medium Access Control) retransmission control, including, for example, an HARQ transmission process, scheduling, transport format selection, channel coding, an inverse fast Fourier transform (IFFT) process and a precoding process are performed, and the result is transferred to each transmitting/receiving section 103. Furthermore, downlink control signals are also subjected to transmission processes such as channel coding and an inverse fast Fourier transform, and transferred to each transmitting/receiving section 103.

Each transmitting/receiving section 103 converts the downlink signals, which are pre-coded and output from the baseband signal processing section 104 on a per antenna basis, into a radio frequency band. The amplifying sections 102 amplify the radio frequency signals having been subjected to frequency conversion, and transmit the results through the transmitting/receiving antennas 101.

On the other hand, as for uplink signals, radio frequency signals that are received in the transmitting/receiving antennas 101 are each amplified in the amplifying sections 102, converted into baseband signals through frequency conversion in each transmitting/receiving section 103, and input in the baseband signal processing section 104.

In the baseband signal processing section 104, the user data that is included in the input uplink signals is subjected to an FFT process, an IDFT process, error correction decoding, a MAC retransmission control receiving process, and RLC layer and PDCP layer receiving processes, and transferred to the higher station apparatus 30 via the transmission path interface 106. The call processing section 105 performs call processing such as setting up and releasing communication channels, manages the state of the radio base station 10 and manages the radio resources.

FIG. 20 is a diagram to show an overall structure of a user terminal 20 according to the present embodiment. The user terminal 20 has a plurality of transmitting/receiving antennas 201 for MIMO transmission, amplifying sections 202, transmitting/receiving sections 203, a baseband signal processing section 204 and an application section 205.

As for downlink signals, radio frequency signals that are received in a plurality of transmitting/receiving antennas 201 are each amplified in the amplifying sections 202, subjected to frequency conversion in the transmitting/receiving sections 203, and input in the baseband signal processing section 204. In the baseband signal processing section 204, an FFT process, error correction decoding, a retransmission control receiving process and so on are performed. The user data that is included in the downlink signals is transferred to the application section 205. The application section 205 performs processes related to higher layers above the physical layer and the MAC layer. The broadcast information in the downlink data is also transferred to the application section 205.

Meanwhile, uplink user data is input from the application section 205 to the baseband signal processing section 204. In the baseband signal processing section 204, a retransmission control (H-ARQ (Hybrid ARQ)) transmission process, channel coding, precoding, a DFT process, an IFFT process and so on are performed, and the result is transferred to each transmitting/receiving section 203. Baseband signals that are output from the baseband signal processing section 204 are converted into a radio frequency band in the transmitting/receiving sections 203. After that, the amplifying sections 202 amplify the radio frequency signals having been subjected to frequency conversion, and transmit the results from the transmitting/receiving antennas 201.

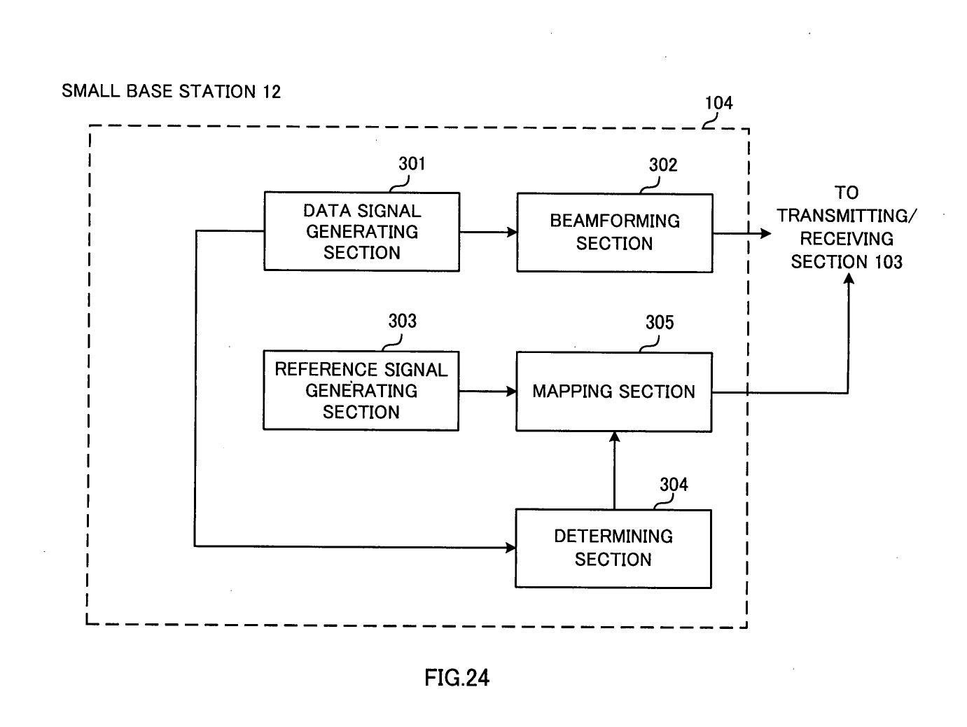

FIG. 24 is a diagram to show a functional structure of a small base station 12 according to the present embodiment. Note that the following functional structure is formed with the baseband signal processing section 104 provided in the small base station 12 and so on. As shown in FIG. 24, the small base station 12 has a data signal generating section 301, a beamforming section 302, a reference signal generating section 303, a determining section 304 and a mapping section 305.

The data signal generating section 301 generates data signals, which are transmitted in data transmission periods (second transmission periods), and outputs the signals to the beamforming section 302. As noted earlier, the data signals include user data that is transmitted in the PDSCH, higher layer control information and so on. The data signals output to the transmitting/receiving sections 103 are subjected to beamforming in the data transmission periods and transmitted (FIG. 9).

The beamforming section 302 applies beamforming to the user terminal 20 based on the feedback information (for example, CSI, AOA, AOD, etc.) from the user terminal 20. To be more specific, the beamforming section 302 assigns weights to the data signals output from the data signal generating section 301, and outputs the result to the transmitting/receiving sections 103.

The reference signal generating section 303 generates reference signals, which are transmitted in reference signal transmission periods (first signal transmission periods), and outputs these signals to the mapping section 305. To be more specific, the reference signal generating section 303 generates a plurality of reference signals that vary per antenna port. As noted earlier, the reference signals may be the CRS, the CSI-RS, the DM-RS, the discovery signal and so on, but may be any signals as long as the signals are used to measure the received quality of each antenna port. The generating section of the present invention is constituted with the reference signal generating section 303.

The determining section 304 determines the transmission bandwidth in the reference signal transmission periods based on the gain by the beamforming in the beamforming section 302 (beamforming gain). To be more specific, the determining section 304 determines the transmission bandwidth of the reference signal transmission periods narrower than in the data transmission periods, based on the beamforming gain in the data transmission periods. By this means, the transmit power of the reference signal periods increases beyond the data transmission periods, in proportion to the transmission bandwidth.

The mapping section 305 maps the reference signals generated in the reference signal generating section 303 to radio resources in the transmission bandwidth determined in the determining section 304. To be more specific, the mapping section 305 multiplexes a plurality of reference signals that vary per antenna port, by using at least one of frequency division multiplexing and code division multiplexing. For example, the mapping section 305 may map these plurality of reference signals to orthogonal frequency resources (for example, subcarriers, PRBs, PRB pairs and so on), and frequency-division-multiplexes the reference signals (example 1, example 2, example 3 and example 4). Also, the mapping section 305 may multiply these plurality of reference signals by orthogonal codes (for example, OCCs), and code-division-multiplex the reference signals (example 2 and example 4).

Also, the mapping section 305 spreads the reference signals of each antenna port in at least one of the time direction and the frequency direction. To be more specific, the mapping section 305 may map the reference signals of each antenna port to a plurality of OFDM symbols in one subframe, and spread the reference signals in the time direction (example 1.1, example 2.1, example 3.1 and example 4.1). Alternatively, the mapping section 305 may map the reference signals of each antenna port to a plurality of OFDM symbols that stretch over a plurality of subframes, and spread the reference signals in the time direction (example 1.2, example 2.2, example 3.2 and example 4.2).

Also, the mapping section 305 may map the reference signals of each antenna port to a plurality of subcarriers, and spread the reference signals in the frequency direction (example 3 and example 4). Note that the mapping section 305 may spread the reference signals of each antenna port by using orthogonal codes (see antenna port #4 of FIG. 19).

The reference signals mapped to radio resources in the mapping section 305 are output to the transmitting/receiving sections 103, and, in the reference signal transmission periods, transmitted in a transmission bandwidth that is narrower than in the data transmission periods. By this means, the reference signals are transmitted with greater transmit power than in the data transmission periods. Note that the transmission section of the present invention is constituted with the mapping section 305 and the transmitting/receiving sections 103.

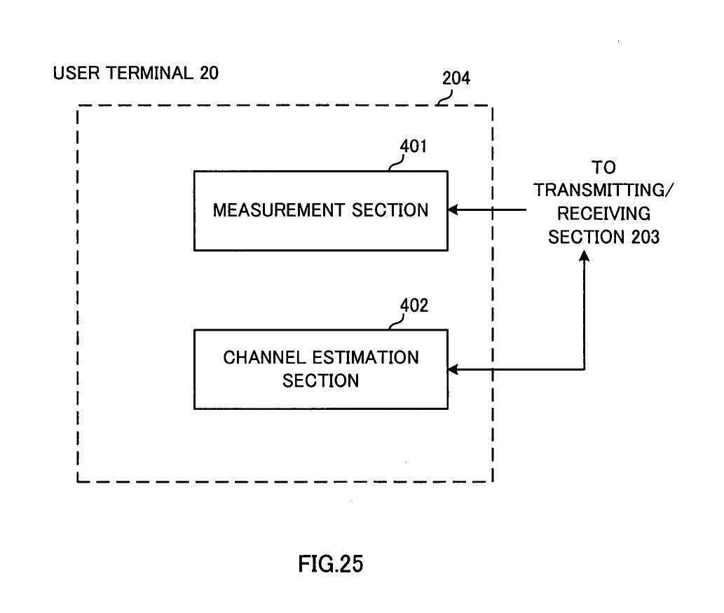

FIG. 25 is a diagram to show a functional structure of a user terminal 20 according to the present embodiment. Note that the following functional structure is constituted with the baseband signal processing section 204 provided in the user terminal 20 and so on. As shown in FIG. 25, the user terminal 20 has a measurement section 401 and a channel estimation section 402.

The measurement section 401 measures the received quality of the reference signals received in the transmitting/receiving sections 203 from the small base station 12. To be more specific, the measurement section 401 measures the received quality of a plurality of reference signals, which vary per antenna port. To be more specific, the measurement section 401 adds up the reference signals of each antenna port that are spread in at least one of the time direction and the frequency direction (for example, in in-phase addition), and measures the received quality of each antenna port's reference signals. As noted earlier, the received quality includes the RSRP, the RSRQ, the SINR and so on.

For example, the measurement section 401 may add up, in-phase, the reference signals of each antenna port that are mapped to a plurality of OFDM symbols in one subframe (example 1.1, example 2.1, example 3.1 and example 4.1). Alternatively, the measurement section 401 may add up, in-phase, the reference signals of each antenna port that are mapped to plurality of OFDM symbols that stretch over a plurality of subframes (example 1.2, example 2.2, example 3.2 and example 4.2).

Also, the measurement section 401 may add up, in-phase, the reference signals of each antenna port that are mapped to a plurality of subcarriers (example 3 and example 4). Also, the measurement section 401 may add up, in-phase, the reference signals of each antenna port that are spread using orthogonal codes (see antenna port #4 of FIG. 19). The measurement section of the present invention is constituted with the measurement section 401. Also, the receiving section of the present invention is constituted with the transmitting/receiving sections 203.

The channel estimation section 402 carries out channel estimation based on the received quality measured in the measurement section 401. To be more specific, the channel estimation section 402 generates channel state information (CSI) that corresponds to the received quality measured in the measurement section 401, on per antenna port basis, and output this information to the transmitting/receiving sections 203. Note that the CSI may include CQI (Channel Quality Indicator), PMI (Precoding Matrix Indicator), RI (Rank Indicator) and so on.

As described above, with the radio communication system 1 according to the present embodiment, a small base station 12 spreads and transmits the reference signals of each antenna port in at least one of the time direction and the frequency direction. Consequently, when a plurality of reference signals that vary per antenna port are transmitted in a reference signal transmission period in which the transmission bandwidth is narrowed, it is still possible to improve the received quality of each antenna port's reference signals in user terminals, and, furthermore, increase the transmit power of the reference signals and expand the coverage.

Note that, although the radio communication system 1 according to the present embodiment is configured to transmit reference signals in a reference signal transmission period in a transmission bandwidth that is narrower than in a data transmission period, this is by no means limiting. The present invention is applicable even when the transmission bandwidth is not narrowed.

Now, although the present invention has been described in detail with reference to the above embodiments, it should be obvious to a person skilled in the art that the present invention is by no means limited to the embodiments described herein. The present invention can be implemented with various corrections and in various modifications, without departing from the spirit and scope of the present invention defined by the recitations of the claims. Consequently, the descriptions herein are provided only for the purpose of explaining examples, and should by no means be construed to limit the present invention in any way.

The disclosure of Japanese Patent Application No. 2013-135706, filed on Jun. 28, 2013, including the specification, drawings and abstract, is incorporated herein by reference in its entirety.

1. A radio base station that forms a small cell, which is arranged to overlap a macro cell, and that has a plurality of antenna ports, the radio base station comprising:
a generating section that generates a plurality of reference signals that vary per antenna port; and
a transmission section that, in a first signal transmission period in which beamforming is not executed, transmits the plurality of reference signals in a transmission bandwidth that is narrower than in a second transmission period in which beamforming is executed,
wherein the transmission section spreads and transmits the reference signals of each antenna port in at least one of a time direction and a frequency direction.

2. The radio base station according to claim 1, wherein the transmission section maps the reference signals of each antenna port to a plurality of OFDM symbols in one subframe and spreads the reference signals in the time direction.

3. The radio base station according to claim 1, wherein the transmission section maps the reference signals of each antenna port to a plurality of OFDM symbols that stretch over a plurality of subframes and spreads the reference signals in the time direction.

4. The radio base station according to claim 1, wherein the transmission section maps the reference signals of each antenna port to a plurality of subcarriers and spreads the reference signals in the frequency direction.

5. The radio base station according to claim 1, wherein the transmission section multiplexes the plurality of reference signals upon the transmission bandwidth by at least one of frequency division multiplexing and code division multiplexing.

6. The radio base station according to claim 1, wherein the transmission section transmits the reference signals of each antenna port by using a second carrier of a higher frequency band than a first carrier that is used in the macro cell.

7. A user terminal that is used in a radio communication system in which a macro cell and a small cell are arranged to overlap each other, the user terminal comprising:
a receiving section that receives a plurality of reference signals that vary per antenna port, from a radio base station that forms the small cell and that has a plurality of antenna ports; and
a measurement section that measures received quality of the plurality of reference signals,
wherein the measurement section performs in-phase addition of the reference signals of each antenna port that are spread in at least one of a time direction and a frequency direction, and measures the received quality of the reference signals of each antenna port.

8. A reference signal transmission method in a radio base station that forms a small cell, which is placed to overlap a macro cell, and that has a plurality of antenna ports, the method comprising the steps of:
generating a plurality of reference signals that vary per antenna port; and in a first signal transmission period in which beamforming is not executed, transmitting the plurality of reference signals in a transmission bandwidth that is narrower than in a second transmission period in which beamforming is executed,
wherein the reference signals of each antenna port are spread in at least one of a time direction and a frequency direction and transmitted.
